(19) United States
(12) Patent Application Publication
(10) Pub. No.: US 2024/0239941 A1
(43) Pub. Date: Jul. 18, 2024

(54) ULTRASOFT, STRETCHABLE, REVERSIBLE ELASTOMERS FOR DIRECT-WRITE PRINTING DEFORMABLE STRUCTURES

(71) Applicant: University of Virginia Patent Foundation, Charlottesville, VA (US)

(72) Inventors: Liheng Cai, Charlottesville, VA (US); Shifeng Nian, Charlottesville, VA (US); Jinchang Zhu, Charlottesville, VA (US)

(73) Assignee: University of Virginia Patent Foundation, Charlottesville, VA (US)

(21) Appl. No.: 18/018,848

(22) PCT Filed: Apr. 23, 2021
(86) PCT No.: PCT/US2021/028987

§ 371 Date: Jan. 30, 2023

Related U.S. Application Data
(60) Provisional application No. 63/059,779, filed on Jul. 31, 2020.

(51) Int. Cl. C08F 293/00; B33Y 10/00; B33Y 70/00; C08L 53/00

(52) U.S. Cl. CPC C08F 293/005; B33Y 10/00; B33Y 70/00; C08L 53/005; C08F 2438/01

(57) ABSTRACT

Existing feedstock for additive manufacturing is mostly stiff, fragile plastics. We report a class of 3D printable, ultrasoft and stretchable elastomers by exploiting the self-assembly of responsive bottlebrush-based triblock copolymers. The microphase separation of the architecturally and chemically distinct blocks results in physically crosslinked networks that are stimuli-reversible, enabling their use for in-situ direct-write printing soft, elastic, and deformable 3D structures. The elastomers are 100% solvent-reprocessable yet thermostable within a wide range of temperature. Moreover, they exhibit an extensibility up to 600% and a Young's modulus low to ˜10² Pa, 10⁶ times softer than plastics and more than 100 times softer than all existing 3D printable elastomers.

### CROSS REFERENCE TO RELATED APPLICATIONS

The present application is a national stage filing of International Application No. PCT/US2021/028987, filed Apr. 23, 2021, which claims benefit of priority under U.S.C. § 119 (e) from U.S. Provisional Application Ser. No. 63/059,779, filed Jul. 31, 2020, entitled “Ultrasoft, Stretchable, Reversible Elastomers for Direct-Write Printing Deformable Structures”; the disclosures of which are hereby incorporated by reference herein in their entirety.

### STATEMENT OF GOVERNMENT INTEREST

This invention was made with government support under Grant No. DMR-1944625, awarded by the National Science Foundation. The government has certain rights in the invention.

### FIELD OF INVENTION

The present invention relates generally to the field of block copolymer chemistry. More particularly, the present disclosure relates to the 3D printing of an ultrasoft, stretchable elastomer comprised of segments of bottle-brush based triblock copolymers. These elastomers are thermostable within a wide temperature range, and exhibit significant extensibility and softness as compared to plastics and other 3D printable elastomers.

### BACKGROUND

Additive manufacturing, or 3D printing, produces customized objects by combining computer-aided design with 3D printing techniques, and can create multi-length scale structures inaccessible by conventional molding.^{[1-3]} Yet existing feedstock for 3D printing is nearly all plastics, such as photocurable resins, thermoplastics, and thermosets.^{[2,4,5]} All these materials are not only stiff with Young's moduli of 10⁸-10¹⁰ Pa, but also fragile with typical extensibility below 10%.^{[5]} By contrast, elastomers are much softer and more deformable. Thus, it has been innovated in both technology^{[6-8]} and materials development^{[9-11]} to 3D print elastomers, based on which are created functional structures and devices such as tissue scaffolds,[^{12,13]} sensors,^{[14]} actuators,^{[15,16]} and soft robots.^{[8,17]} The basic materials, however, are limited to thermo-reversible liquid crystal elastomers and a few photo- or thermo-curable elastomers.^{[15,18-20]} Although the moduli of these elastomers, 10⁶-10⁸ Pa, are much lower than that of plastics, they remain orders of magnitude higher than that of ultrasoft biological tissues, 10²-10⁵ Pa.^{[21]} The further lowering of the stiffness of elastomers to this resulting range may significantly broaden their applications. One example is hydrogels.^{[22-24]} However, hydrogels contain a large amount of water that can evaporate or leach out, and in doing so material properties will deteriorate. It remains a challenge to develop 3D printable, ultrasoft, yet solvent-free elastomers.

There is therefore a need in the art for an effective 3D printable, ultrasoft, and solvent-free elastomer.

### SUMMARY OF ASPECTS OF EMBODIMENTS OF THE PRESENT INVENTION

The present inventor seeks to overcome this challenge by exploiting the self-assembly of a responsive ABA triblock copolymer, in which the A blocks are a linear polymer of relatively high glass transition temperature T_{g}, whereas the B block is a bottlebrush polymer with a linear backbone densely grafted by low T_{g} linear polymers (FIG. 1(A)). At room temperature, the triblock copolymer self-assembles to a network, in which effective crosslinks are spherical hard glassy domains formed by the high T_{g} end blocks, whereas the soft elastic network strands are the low T_{g} bottlebrush polymer (FIG. 1(B). These crosslinks create glassy domains present within the triblock copolymer. Compared to a linear polymer, a bottlebrush polymer has a much higher entanglement molecular weight.^{[25]} This not only prevents the formation of entanglements but also enables low density of crosslinks, resulting bottlebrush-based elastomers of extreme softness.^{[26-28]} Moreover, above the melting point of the end blocks or in the presence of solvent, the glassy domains dissociate, such that the solid network becomes liquid-like. Such a stimuli-triggered solid-to-liquid transition would allow the elastomers for direct-write 3D printing (FIG. 1(C)).

More specifically, the present invention provides, among other things, 3D printable, ultrasoft, stretchable elastomers that are developed by exploiting the self-assembly of responsive bottlebrush-based triblock copolymers. The microphase separation of the architecturally and chemically distinct blocks results in physically crosslinked networks that are stimuli-reversible, enabling their use for direct-write printing deformable 3D structures. The elastomer claimed herein exhibits an extensibility up to 600% and a Young's modulus minimum of ˜10² Pa. This is 100 times softer than all existing 3D printable elastomers.

Other embodiments of the present invention include among other things, an ultrasoft, stretchable, reversible elastomers for direct-write printing deformable structures, as well as soft elastomers for additive manufacturing.

Existing feedstock for additive manufacturing, or 3D printing, are nearly all plastics, which are not only stiff with elastic moduli above 10⁸ Pa but also fragile with breaking strain below 10%. An aspect of an embodiment of the present invention provides, among other things, the design and fabrication of a new class of thermo-reversible soft elastomers for additive manufacturing. Unlike conventional stiff, fragile plastics, these elastomers are soft with elastic moduli in the range of 1 kPa-100 kPa and extensible with breaking strain >100%. Moreover, these materials are solid at room temperature, but become liquid at high temperature. Such a temperature triggered solid-to-liquid transition allows the elastomers amenable extrusion-based 3D printing. Using temperature triggered direct-ink-writing, we create a complex, hierarchical 3D structure with an exceptional combination of softness and deformability that are inaccessible by conventional 3D printable polymers.

The polymer network formed by the self-assembly of the triblock copolymers (FIG. 1(B)) with novel properties gives rise to numerous possible articles. These articles include, but are not limited to, implantable medical devices, implantable portions of vocal cord prostheses, and permanent fillers for vesicoureteral reflux.

An aspect of an embodiment of the present invention provides, among other things, a triblock copolymer comprising: a linear polymer wherein the linear polymer creates glassy domains within the triblock copolymer, and a bottlebrush polymer, wherein the bottlebrush polymer connects the glassy domains.

An aspect of an embodiment of the present invention provides, among other things, a triblock copolymer comprising: a linear polymer, wherein the linear polymer is poly(benzyl methacrylate); and a bottlebrush polymer, wherein the bottlebrush polymer is comprised of polydimethylsiloxane side chains, wherein the bottlebrush polymer is situated between two of the linear polymers.

An aspect of an embodiment of the present invention provides, among other things, a method of making a triblock copolymer, comprising: synthesizing a bottlebrush polymer; and adding one or more of the linear polymer to the bottlebrush polymer to yield the triblock copolymer.

An aspect of an embodiment of the present invention provides, among other things, a polymer network comprising a plurality of triblock copolymers, wherein: the bottlebrush polymers configured to operate as elastic network strands; and the linear polymers aggregate to form spherical glassy domains.

An aspect of an embodiment of the present invention provides, among other things, a method for 3D printing an elastomer, comprising: adding a solvent to polymer network at a specified pressure in a chamber of a 3D printer apparatus; transferring the polymer network with the solvent from a printer nozzle of the 3D printer apparatus; and wherein the solvent evaporates after exiting the nozzle and the glassy domains of the polymer network reassociate.

An aspect of an embodiment of the present invention system and method provides, among other things, a class of 3D printable, ultrasoft and stretchable elastomers by exploiting the self-assembly of responsive bottlebrush-based triblock copolymers. The microphase separation of the architecturally and chemically distinct blocks results in physically crosslinked networks that are stimuli-reversible, enabling their use for in-situ direct-write printing soft, elastic, and deformable 3D structures. The elastomers are 100% solvent-reprocessable yet thermostable within a wide range of temperature. Moreover, they exhibit an extensibility up to 600% and a Young's modulus low to ˜10² Pa, 10 times softer than plastics and more than 100 times softer than all existing 3D printable elastomers.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It should be appreciated that any of the compositions referred to with regards to any of the present invention embodiments discussed herein, may be integrally or separately formed with one another. Moreover, various compositions may be substituted with other modules or components that provide similar functions.

It should be appreciated that the device and related components discussed herein may take on all shapes along the entire continual geometric spectrum of manipulation of x, y and z planes to provide and meet the environmental, anatomical, and structural demands and operational requirements. Moreover, locations and alignments of the various components may vary as desired or required.

It should be appreciated that various sizes, dimensions, contours, rigidity, shapes, flexibility and materials of any of the components or portions of components in the various embodiments discussed throughout may be varied and utilized as desired or required.

It should be appreciated that while some dimensions are provided on the aforementioned figures, the device may constitute various sizes, dimensions, contours, rigidity, shapes, flexibility and materials as it pertains to the components or portions of components of the device, and therefore may be varied and utilized as desired or required.

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, or method steps, even if the other such compounds, material, particles, or method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the n^{th} reference in the list. All references cited and discussed in this specification are incorporated herein by reference in their entireties and to the same extent as if each reference was individually incorporated by reference.

It should be appreciated that as discussed herein, a subject may be a human or any animal. It should be appreciated that an animal may be a variety of any applicable type, including, but not limited thereto, mammal, veterinarian animal, livestock animal or pet type animal, etc. As an example, the animal may be a laboratory animal specifically selected to have certain characteristics similar to human (e.g. rat, dog, pig, monkey), etc. It should be appreciated that the subject may be any applicable human patient, for example.

As discussed herein, a “subject” may be any applicable human, animal, or other organism, living or dead, or other biological or molecular structure or chemical environment, and may relate to particular components of the subject, for instance specific tissues or fluids of a subject (e.g., human tissue in a particular area of the body of a living subject), which may be in a particular location of the subject, referred to herein as an “area of interest” or a “region of interest.”

The term “about.” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g. 1 to 5 includes 1, 1.5, 2, 2.75, 3, 3.90, 4, 4.24, and 5). Similarly, numerical ranges recited herein by endpoints include subranges subsumed within that range (e.g. 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The invention itself, together with further objects and attendant advantages, will best be understood by reference to the following detailed description, taken in conjunction with the accompanying drawings.

These and other objects, along with advantages and features of various aspects of embodiments of the invention disclosed herein, will be made more apparent from the description, drawings and claims that follow.

### BRIEF DESCRIPTION OF THE DRAWINGS

The foregoing and other objects, features and advantages of the present invention, as well as the invention itself, will be more fully understood from the following description of preferred embodiments, when read together with the accompanying drawings

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

FIG. 1 schematically illustrates the design concept of soft, 3D printable elastomers.

FIG. 2 graphically illustrates that the self-assembled network is an optically transparent, soft, stretchable, and reversible elastomer.

FIG. 3 schematically illustrates direct-write printing soft elastomers to create deformable 3D structures.

FIG. 4 graphically illustrates the mechanical properties of 3D printable elastomers.

FIG. 5 schematically illustrates the chemical synthesis procedure of bottlebrush and linear-bottlebrush-linear (LBBL) triblock copolymers.

FIG. 6 graphically illustrates the ¹H nuclear magnetic resonance (NMR) spectra of bbPDMS and LBBL polymers.

FIG. 7 graphically illustrates the gel permeation chromatography (GPC) of all bbPDMS and LBBL polymers.

FIG. 8 graphically illustrates the quantification of the characteristic length scales of ultrasoft elastomers.

FIG. 9 graphically illustrates the characterization of the microstructure of ultrasoft elastomers.

FIG. 10 graphically illustrates the effects of temperature on the microstructure and mechanical properties of the elastomer.

FIG. 11 graphically illustrates that the ultrasoft elastomers are 100% solvent reprocessable.

FIG. 12 graphically illustrates the dependence of stiffness and extensibility on molecular weight of LBBL polymers.

FIG. 13 graphically illustrates an Ashby plot for the extensibility and the Young's moduli of existing 3D printable hydrogels and our ultrasoft elastomers.

FIG. 14 schematically illustrates the 3D printing of the UVA logo.

FIG. 15 schematically illustrates the 3D printing of the cubic gyroid in process.

FIG. 16 schematically illustrates the compression tests for the bulk elastomer.

FIG. 17 schematically illustrates the compression tests for a cubic gyroid printing using our ultrasoft elastomer.

FIG. 18 schematically illustrates an embodiment of a cubic gyroid printed using our ultrasoft elastomer.

### DETAILED DESCRIPTION OF EXEMPLARY EMBODIMENTS

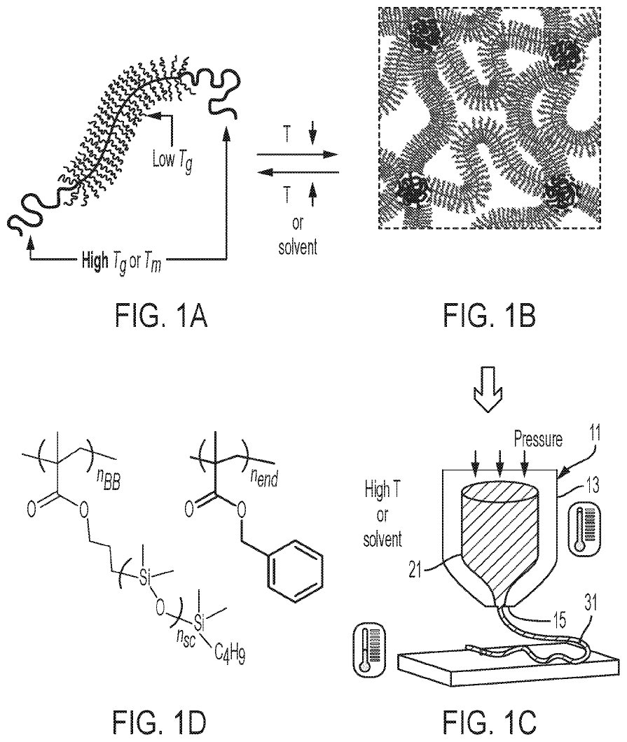

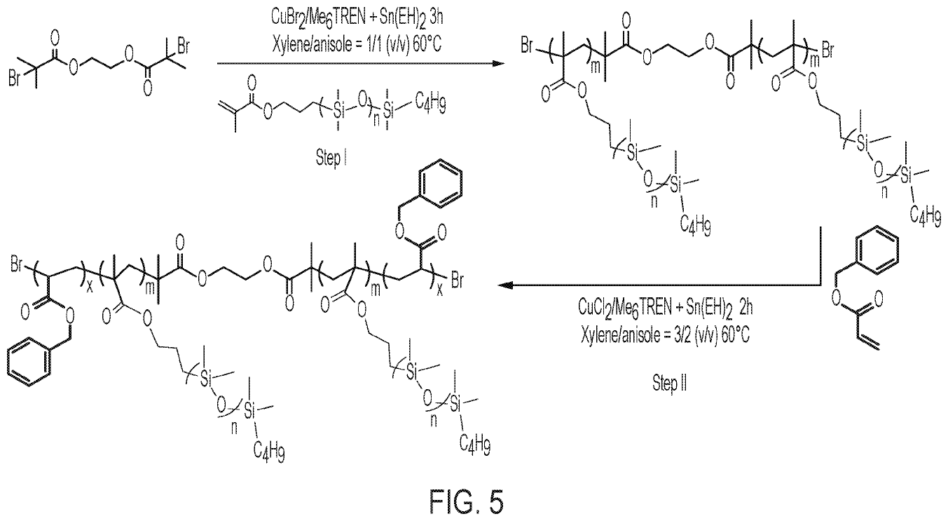

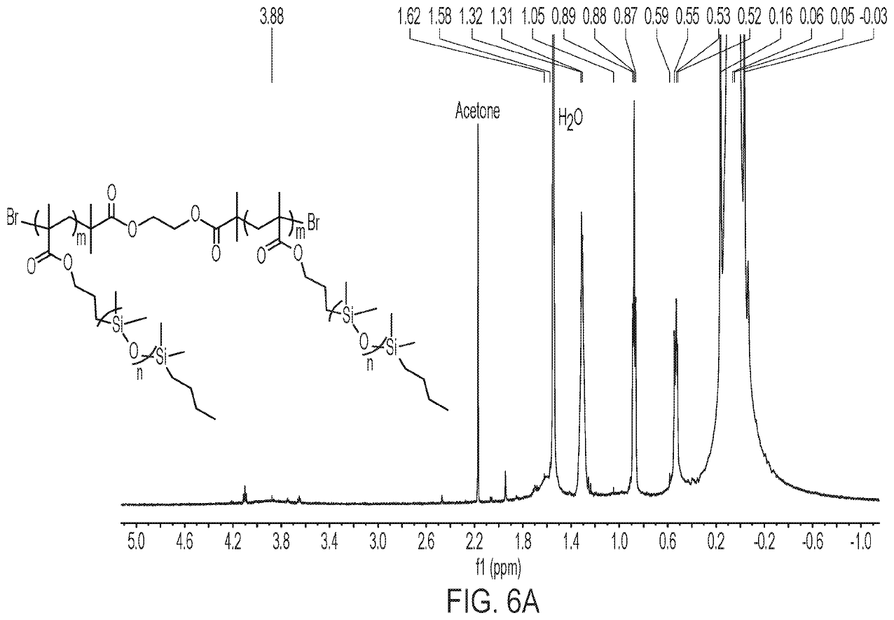

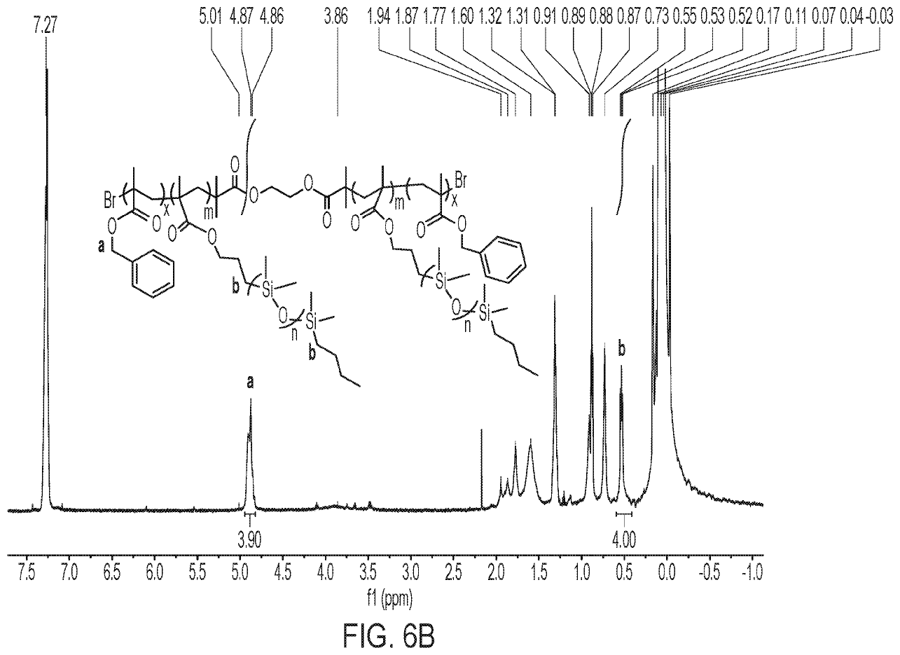

An aspect of an embodiment of the present invention provides the use of polydimethylsiloxane (PDMS) and poly(benzyl methacrylate) (PBnMA) as the two polymer species to synthesize the bottlebrush-based ABA triblock copolymer (FIG. 1(D)). We select PDMS and PBnMA because of two reasons. First, PDMS has an extremely low glass transition temperature T_{g,PDMS} of −125° C. whereas PBnMA has a T_{g,PBnMA} of 54° C. and a melting temperature T_{m,PBnMA} of 200° C.^{[29]} Such a large difference between T_{g,PDMS} and T_{m,PBzMA} ensures that the self-assembled network is thermostable within a wide range of temperature. Second, reminiscent of PDMS and polystyrene,^{[27]} PDMS and PBnMA are highly incompatible to result in a strongly segregated microphase separation. Compared to the weak segregation limit, a strongly segregated microstructure is less sensitive to annealing conditions and thus would result in controllable macroscopic properties.^{[30]} An aspect of an embodiment of the present invention may include the synthesis of PBnMA-bottlebrush PDMS (bbPDMS)-PBnMA triblock copolymers using a two-step procedure. The first step involves synthesizing the bottlebrush polymer which requires the synthesis of first the middle bbPDMS block, and adding one or more linear polymer units (PBnMA) to yield a triblock copolymer. (FIG. 5). A linear PDMS polymer of a relatively large molecular weight (MW), 5000 g/mol, is used as the macromonomer, or the side chain, of the bottlebrush. The entanglement MW of the bottlebrush of such a molecular architecture is about 10⁸ g/mol;^{[28]} this high value ensures that all the samples explored in this study are unentangled. The present inventor notes that it is difficult, however, to synthesize bottlebrush polymers of long side chains and high molecular weight. The strong steric repulsion between the densely grafted long side chains geometrically hinders the addition of macromonomers to the propagating bottlebrush, and this steric hindrance becomes more pronounced in good solvents. In addition, the solubility of polymers decreases with the increase of molecular weight. Moreover, PDMS and PBnMA are intrinsically immiscible without co-solvents. To overcome these challenges, the present inventor extends its previous procedure for the synthesis of bottlebrush polymers,^{[27]} but in each step uses different co-solvents with carefully adjusted solvent quality to mitigate the steric repulsions from the densely grafted side chains while ensuring the solubility of final products (see Materials and Methods Section). For all polymers, the present inventor confirms chemical synthesis using nuclear magnetic resonance (NMR) spectroscopy, quantifies number average MW based on the conversion rate measured by NMR, and determines polydispersity index (PDI) using gel permeation chromatography (GPC) (FIGS. 6 & 7). The parameters for all samples are listed in Table 1 below. For example, for a sample S₅₀₀ with a MW about 500 kg/mol, the PDI of the bottlebrush middle block and the triblock copolymer is of 1.41 and 1.52, respectively. These results demonstrate that the synthesis procedure allows for controlled synthesis of bottlebrush-based ABA triblock copolymers.

Table 1. Molecular parameters and mechanical properties of the 3D printable, ultrasoft, stretchable elastomers, M_{SC}, molecular weight of side chains, n_{BB}, number of side chains per bottlebrush, n_{end}, number of chemical repeating units for the end linear PBnMA blocks; f, weight fraction of the end blocks; PDI, polydispersity index; G, shear modulus: γ_{y}, shear fracture strain of the elastomers, d, average distance between the centers of two neighboring domains.

TABLE 1

| | Middle block | | | | | | | | |
|---|---|---|---|---|---|---|---|---|---|
| | M_{sc} | | | Triblock | | | Mechanical properties | | Microstructure |
| Sample | (kDa) | n_{BB} | PDI | n_{end} | f | PDI | γ_{y} | G (Pa) | d (nm) |
| S₁₀₀ | 5 | 21 | 1.10 | 17 | 0.06 | 1.33 | NA | NA | NA |
| S₂₀₀ | 5 | 44 | 1.27 | 37 | 0.06 | 1.44 | 3.46 | 946 | 20.9 ± 4.6 |
| S₂₅₀ | 5 | 50 | 1.15 | 45 | 0.06 | 1.20 | 2.53 | 4360 | 22.4 ± 6.6 |
| S₅₀₀ | 5 | 112 | 1.41 | 109 | 0.06 | 1.52 | 1.66 | 6082 | 44.9 ± 8.8 |
| S₁₀₀₀ | 5 | 216 | 1.56 | 95 | 0.03 | 1.82 | 3.46 | 244 | 57.1 ± 12.7 |
| S₁₅₀₀ | 5 | 300 | 1.63 | 176 | 0.04 | 2.05 | 5.62 | 57 | 66.8 ± 22.9 |

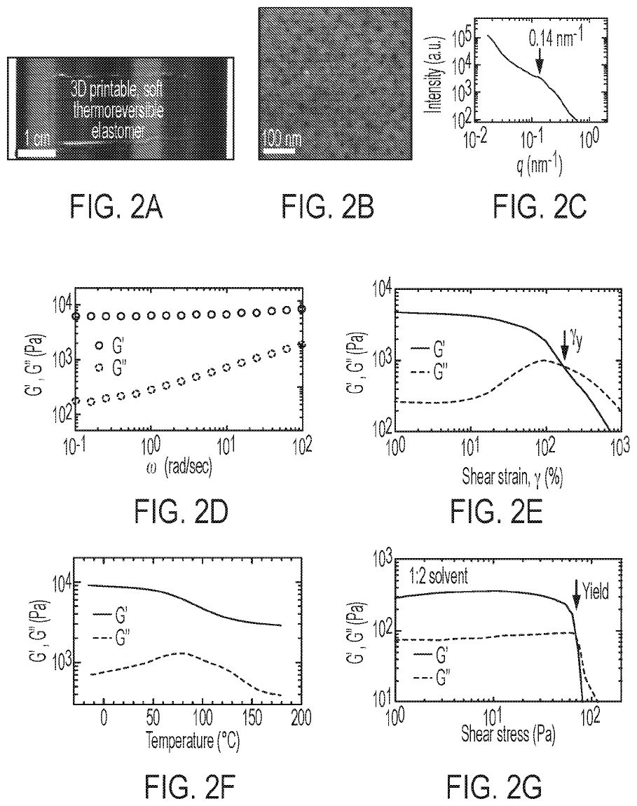

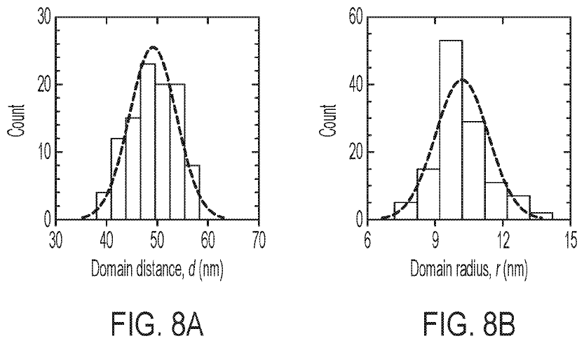

An aspect of an embodiment of the present invention provides using S₅₀₀ as the material for most studies. At room temperature, S₅₀₀ is a solid optically transparent to the full spectra of visible light, as shown in FIG. 6(A). Microscopically, the triblock copolymer microphase separates to form a sphere microstructure, as shown by the dark dots in a transmission electron microscopy (TEM) image (FIG. 2(B)). The average radius of a spherical domain is 10.2±1.2 nm, and the neighboring center-to-center domain distance is 49.2±4.7 nm (FIG. 8). Consistent with this, grazing-incidence small-angle X-ray scattering (GISAXS) reveals a characteristic peak at the wavenumber q=0.14 nm⁻¹, associated with a length of 44.8 nm (FIG. 2(C)). These results confirm that the ABA triblock copolymers form a physically crosslinked network, in which the crosslinks are spherical hard glassy domains formed by linear PBnMA, whereas the network strands are soft elastic bottlebrush PDMS.

An aspect of an embodiment of the present invention includes the use of a stress-controlled rheometer to quantify the dynamic mechanical properties of the polymer network. Reminiscent of a perfect rubber.^{[31]} the network exhibits nearly a frequency-independent shear storage modulus G′ (solid line circles in FIG. 2(D)). Therefore, value of G′ is taken at the lowest frequency, 0.1 rad/sec. as the equilibrium shear modulus G. The modulus is about 6 kPa, more than 30 times lower than the entanglement modulus, 200 kPa. of linear PDMS.^{[31]} As established in a recent study,^{[32]} in addition to the elongation at break measured by tensile tests, the extensibility of a polymer network can be described by shear fracture strain γ_{y}, a parameter measured by large amplitude oscillatory shear (LAOS).^{[33]} Above γ_{y}, the network fractures and thus the storage modulus becomes smaller than the loss modulus. The self-assembled network exhibits a fracture strain γ_{y}=1.66, as shown in FIG. 2(E). These results indicate that the self-assembled network is a soft, stretchable elastomer.

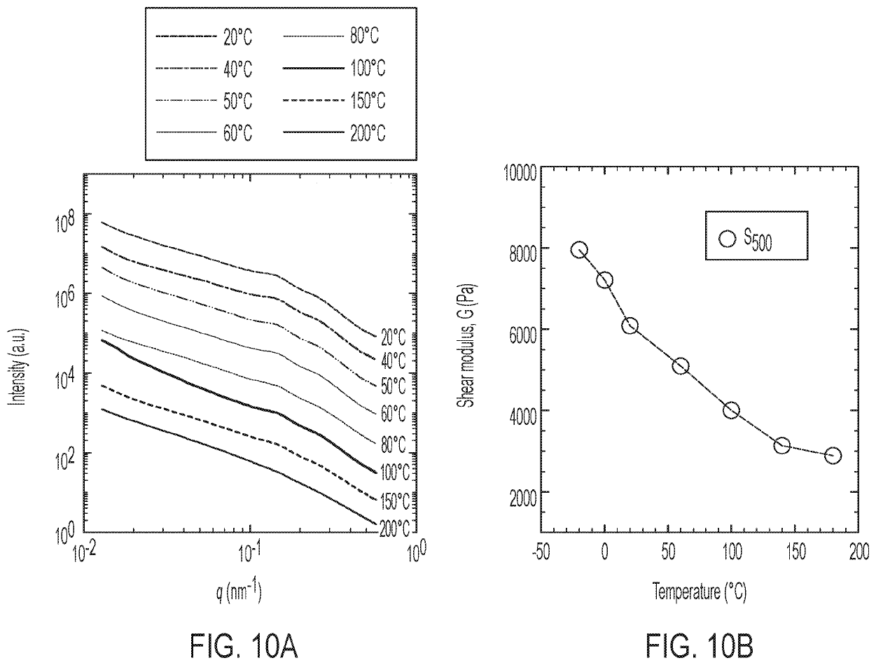

Unlike conventional elastomers in which the crosslinks are permanent chemical bonds, the crosslinks in the self-assembled network are hard, glassy domains, which are physical bonds and expected to dissociate either at a high temperature or in the presence of solvents. To explore this, we monitor in real-time the viscoelasticity of the network from −20° C. to 180° C. At an oscillatory shear frequency of 1 rad/sec, the network remains a solid with G′ nearly 10 times larger than G″ (FIG. 2(F)). Consistent with this, up to 180° C. the network exhibits no change in microstructure, as shown by the characteristic scattering peaks at fixed wavenumbers from in situ GISAXS measurements in FIG. 10(A). By contrast, slightly increasing the temperature to the melting point of glassy domains, 200° C., results in the dissociation of the glassy domains, as indicated by vanished scattering characteristic peaks (bottom line in FIG. 10(A)). This behavior is similar to classical thermoplastic elastomers,^{[34,35]} which are solid at temperature below the melting point of the hard, glassy domains; but compared with them, our elastomers are more than 10³ times softer. Interestingly, as the temperature increases from −20° C. to 180° C., the value of G′ decreases from 8 kPa to 3 kPa (solid line in FIG. 2(F) and FIG. 10(B)). This is because upon heating it accelerates the relaxation of polymers, such that it decreases the number of modes with relaxation time scales at or shorter than 2π sec, the time scale at which the measurements are performed. Importantly, at the highest temperature 180° C., the physical network remains to be a good elastomer with G′ much larger than G″ over a wide range of oscillatory shear frequency from 0.1 to 10² rad/sec (FIG. 10(C)). Such a thermostability is appealing for applications in harsh environments, but poses challenges in applying the material for direct-write 3D printing.

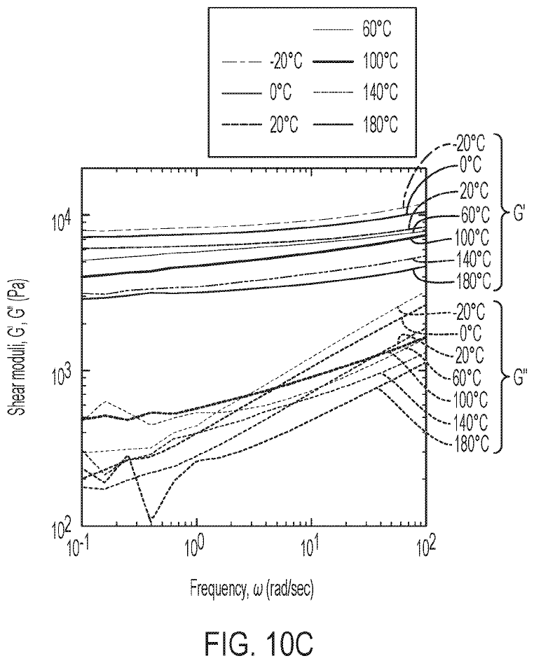

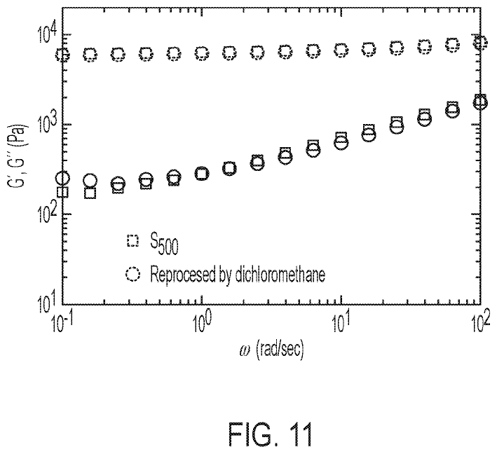

As an alternative, we explore the effects of solvents on the dynamic mechanical properties of the elastomer. Before and after solvent reprocessing, the elastomer exhibits a negligible difference in the viscoelasticity, suggesting the material is nearly 100% reprocessable (FIG. 11). By gradually decreasing the amount of solvent, we find that when dissolved in dichloromethane (DCM) at a 1:2 volume ratio, the mixture becomes a yield stress fluid: it is an elastic solid with a shear modulus of 300 Pa, but becomes liquid-like above shear stress 70 Pa, as shown in FIG. 2(G). Such a material is ideal for direct-write printing^{[1]} the stress yield behavior allows the material to flow through a printer nozzle under stress, but once the stress is released, the solid-like behavior provides mechanical support for the printed features.

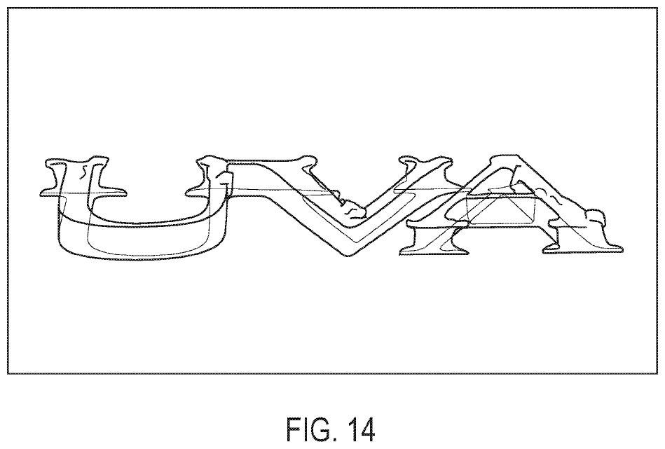

FIG. 14 schematically illustrates an article of manufacture produced from an embodiment of the 3D printing process described herein.

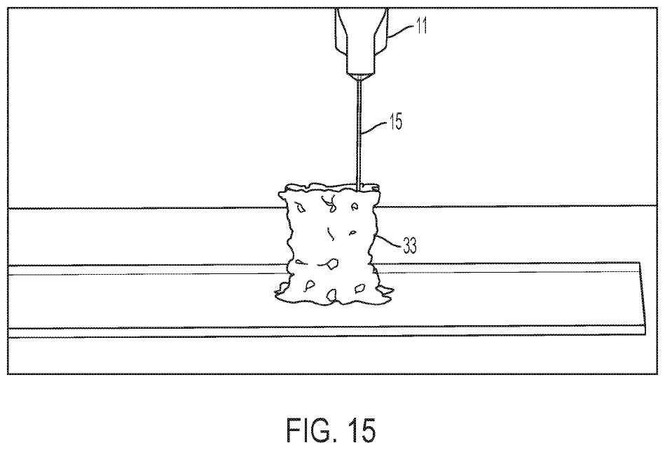

FIG. 15 schematically illustrates an embodiment of a 3D printer 11 having a nozzle 15 that produces a cubic gyroid 33 (in accordance to the printing process described herein).

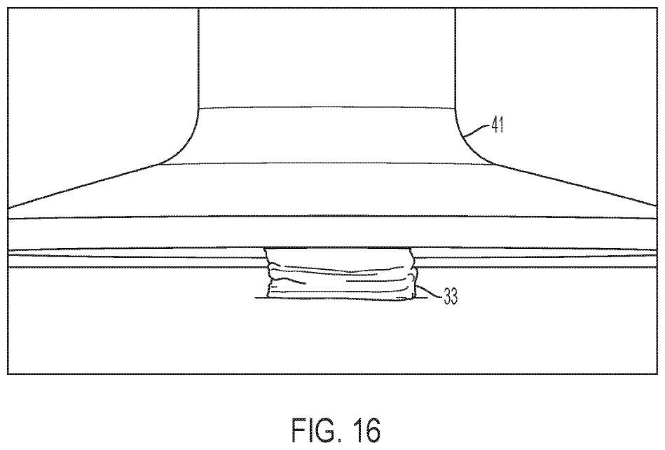

FIG. 16 schematically illustrates a compression test (undertaken by way of a compressor device 41) for a cubic gyroid 33 printed using for the bulk elastomer for a yield compression maximum strain of 80 percent.

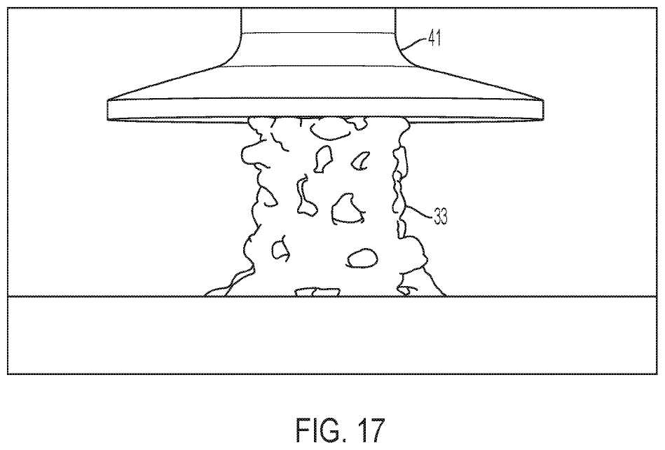

FIG. 17 schematically illustrates a compression test (undertaken by way of a compressor device 41) for a cubic gyroid 33 printed using our ultrasoft elastomer for a yield compression maximum strain of 80 percent.

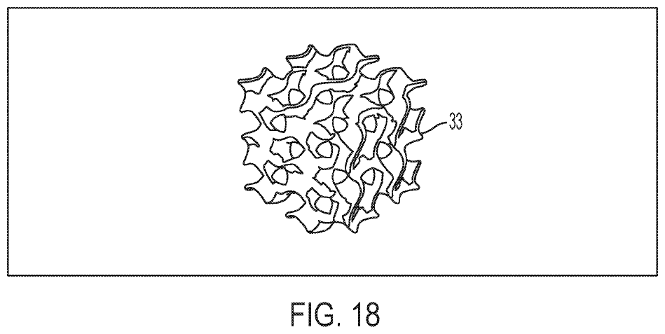

FIG. 18 schematically illustrates an embodiment of for a cubic gyroid 31 printed using our ultrasoft elastomer (in accordance to the printing process described herein).

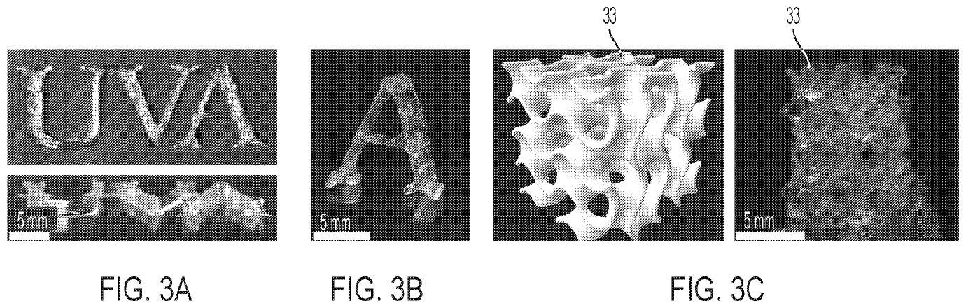

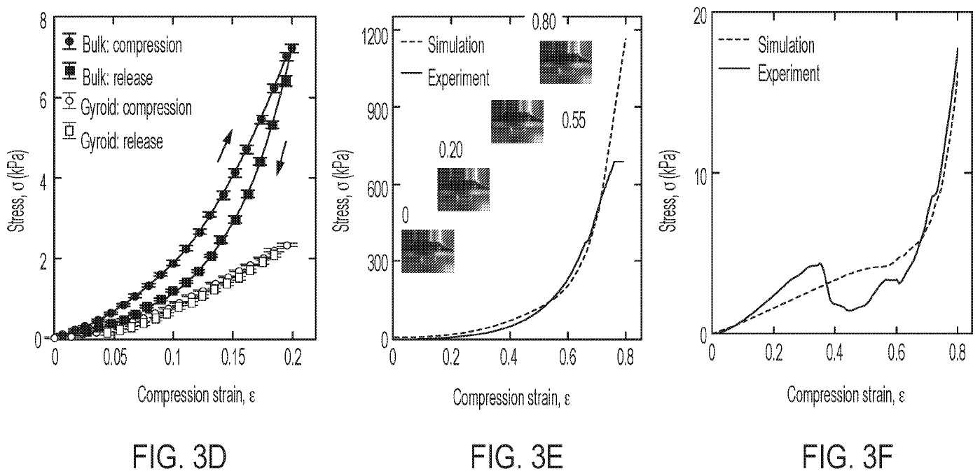

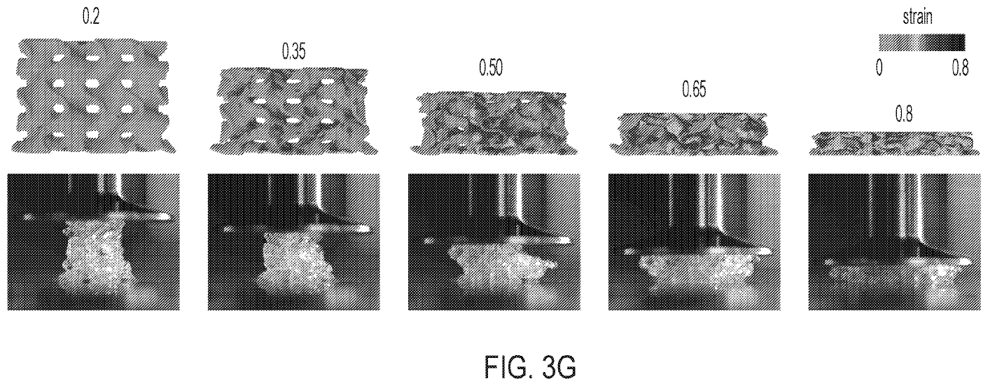

Using the mixture as inks, we demonstrate that the soft elastomers are amenable for direct-write printing 3D structures. The elastomers can be used to print features with a resolution of ˜0.2 mm, as visualized by the sharp edges of a printed UVA logo in FIG. 3(A). Importantly, the solvent is highly volatile and evaporates quickly, such that the printed structure is mechanically strong enough to support itself, as evidenced by FIG. 3(B) and FIG. 14. This contrasts to most soft materials printing, which often requires a sacrificial supporting matrix to provide mechanical support and/or post-processing to completely solidify the printed features.^{[9,14]} Further, in an embodiment a cubic gyroid, a kind of 3D structure inaccessible by conventional molding. Despite nearly 50% of volume shrinkage due to solvent evaporation, the printed cubic gyroid 31 captures the designed features reasonably well (See FIG. 3(C) and FIG. 15). Compared with the bulk sample (solid line in FIG. 3(E) and gyroid illustrated in FIG. 16), the gyroid is two times softer and non-dissipative (FIG. 3(D)), and exhibits a delayed strain-stiffening (solid line in FIG. 3(F) and gyroid illustrated in FIG. 17). The measured stress-strain behavior of the gyroid is qualitatively captured by finite element analysis (FEA), but quantitatively different at intermediate strains (dash line in FIG. 3(F)). This is likely because of defects introduced in 3D printing, which results in a structural collapse under intermediate compression, as shown by the snapshots in FIG. 3(G) and FIGS. 17 and 18. A systematic understanding of how printing conditions such as shear rate and solvent evaporation affect printed structures is beyond the scope of this work and will be the subject of further study. Nevertheless, our results demonstrate that the elastomers are amenable to in-situ direct-write printing complex elastic, deformable 3D structures without the aid of sacrificial supporting matrix.

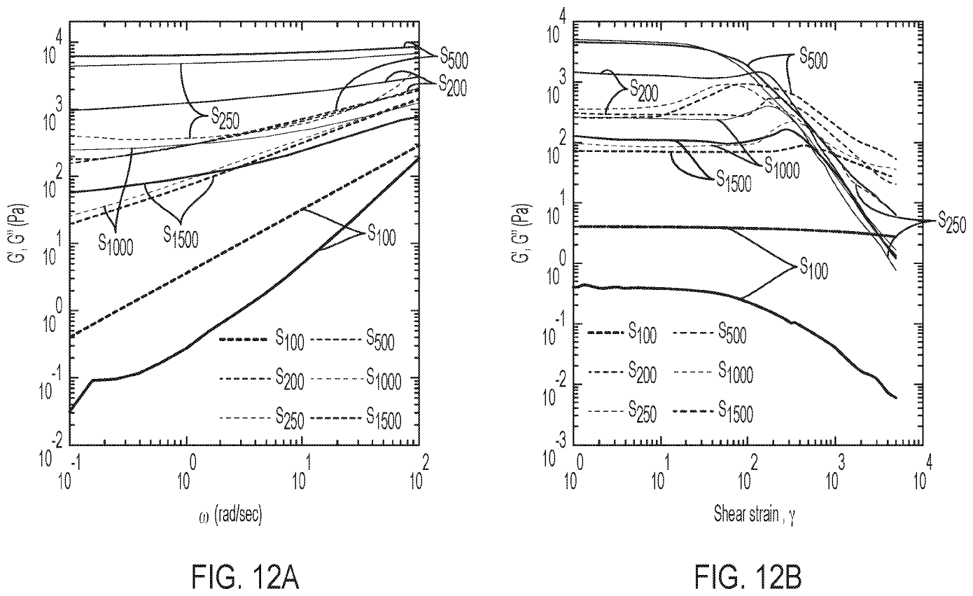

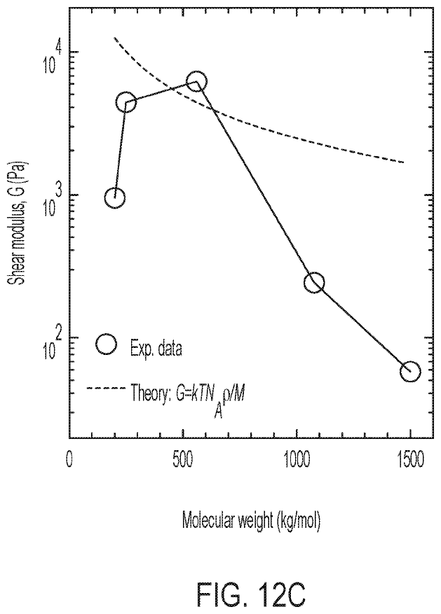

To further explore the limit of our elastomers in mechanical properties, we tune the MW of the bottlebrush block while maintaining the weight fraction of the end blocks below 6%. This ensures that the ABA polymers form a sphere microstructure.^{[27]} By increasing the middle bottlebrush block to 1500 kDa, we create a solvent-free elastomer with a shear modulus of 60 Pa (Table 1, sample S₁₅₀₀ in FIG. 12(A)); this by far, to the best of our knowledge, represents the softest solvent-free elastomer. However, decreasing the middle block MW to 100 kDa does not increase the network stiffness; instead, it results in a viscoelastic liquid as shown by the sample S₁₀₀ in FIG. 12(A). This is because the MW of the end linear blocks 3000 g/mol is too small to form hard glassy domains. Interestingly, the measured network stiffness exhibits a non-monotonic dependence on polymer MW (FIG. 12(C)). This is likely attributed to the formation of loops with two end linear blocks from the same triblock copolymer linking to the same spherical nodule, resulting in elastically ineffective network strands and thus reduced network stiffness. The probability of two ends to meet to form loops increases when the bottlebrush becomes either more flexible or shorter, as confirmed by larger deviations of the measured network stiffness (FIG. 12(C)). Nevertheless, by controlling the MW, we can tune the stiffness of soft elastomers over two orders of magnitude from 60 to −6000 Pa.

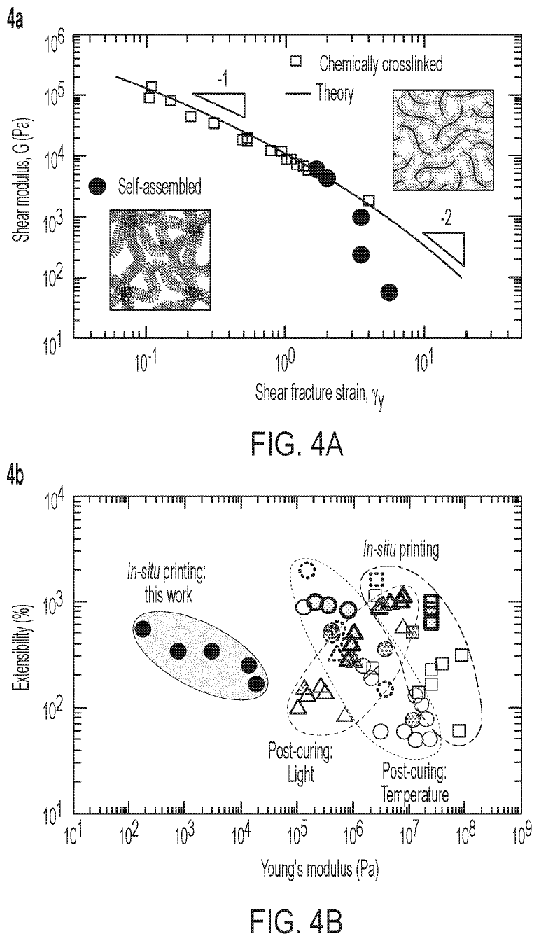

The extensibility of our elastomers, in the form of shear fracture strain γ_{y}, decreases with the increase of shear modulus G referenced in FIG. 4(A) (as depicted by solid filled circles) and FIG. 12(B). This is consistent with the classical understanding that the extensibility of polymer networks is proportional to the network strand size, which becomes smaller at higher stiffness. Indeed, recently it has been discovered^{[32]} that the shear fracture strain of chemically crosslinked bottlebrush polymer networks is equal to the ratio of the contour length Lₘₐₓ to the end-to-end distance R of the bottlebrush between two neighboring crosslinks: γ_{y}=Lₘₐₓ/R−1, as shown by the empty [white filled] square symbols and the solid line (descending line-denoted as Theory) in FIG. 4(A). Both Lₘₐₓ and R are related to the network modulus G, and the molecular theory predicts two regimes: (1) for stiff bottlebrush polymers, γ_{y} is inversely proportional to the network shear modulus G, γ_{y}˜G⁻¹; (2) for flexible bottlebrush polymers, γ_{y}˜G^{-1/2}, which recovers the behavior of conventional networks.^{[32]} Yet, neither of these two scaling relations captures the behavior of the self-assemble network. Moreover, at the same network stiffness, the self-assembled network is less stretchable than the chemically crosslinked bottlebrush polymer networks. Such a difference is likely because in the chemically crosslinked bottlebrush polymer network, the bottlebrush polymer is not pre-strained. By contrast, in the self-assembled network, to balance the interfacial free energy from the incompatible microdomains, the bottlebrush polymer must be pre-strained;^{[27]} this results in a less extensibility. These results highlight the importance of preventing pre-stretching of the bottlebrush network strands to achieve large extensibility.

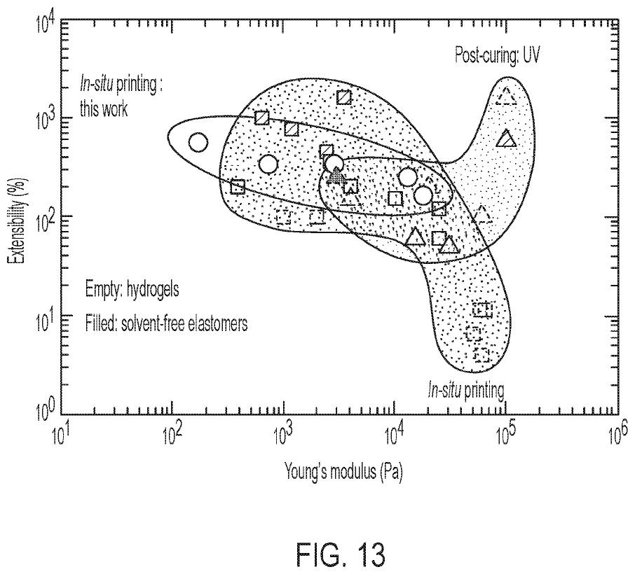

Compared to all existing 3D printable elastomers (Table 2), our elastomers are of more than two orders of magnitude softer, and they can be stretched up to 6 times (FIG. 4(B)). Moreover, they are a kind of physically crosslinked network, reminiscent of conventional thermoplastic elastomers and liquid crystal elastomers but different in extreme softness. The physical crosslinks are stimuli-reversible, enabling instantaneous fixation of printed features. Remarkably, our elastomers are of similar stiffness to 3D printable hydrogels^{[36,37]} but contain no solvents (FIG. 13, Table 3); this may enable their applications in 3D bioprinting solvent-free, permanent scaffolds.^{[38]} Thus, the ultrasoft, stretchable elastomers present a new feedstock for extrusion-based 3D printing. Furthermore, together with their solvent-reprocessability, the soft elastomers can be readily used as matrix materials to create functional polymer-nanoparticle composites^{[39]} for 3D printing. Finally, the design concept of soft reversible elastomers should be general and will enable the development of 3D printable soft elastomers made of other polymers.

TABLE 2
List of data points for Ashby plot in FIG. 4(B).

| | | Symbol | | | |
|---|---|---|---|---|---|
| | | color (i.e., | | | |
| | | shaded or | | | |
| | | empty; | | | |
| | | excludes | | | |
| | | black | Young's | | |
| Printing | Symbol | filled-in | modulus | Extensibility | Reference |
| method | shape | circles) | (kPa) | (%) | number |
| In-situ | Square | Black | 80000 | 60 | [44] |
| printing | | Red | 25000 | 860 | [45] |
| | | | 25000 | 640 | |
| | | | 25000 | 1030 | |
| | | Blue | 2500 | 1600 | [46] |
| | | Green | 11000 | 522 | [47] |
| | | Yellow | 2300 | 1150 | [48] |
| | | | 2300 | 240 | |
| | | Purple | 85000 | 314 | [49] |
| | | | 40000 | 260 | |
| | | | 25000 | 230 | |
| | | | 25000 | 170 | |
| | | | 15000 | 140 | |
| Post-curing: | Circle | Black | 125 | 900 | [50, 51] |
| temperature | | Red | 200 | 1000 | [46] |
| | | | 350 | 930 | |
| | | | 800 | 850 | |
| | | Blue | 3600 | 150 | [52] |
| | | | 500 | 550 | |
| | | | 400 | 480 | |
| | | | 800 | 400 | |
| | | | 150 | 2000 | |
| | | Green | 400 | 528 | [53] |
| | | | 3610 | 362 | |
| | | | 11510 | 77 | |
| | | Yellow | 1500 | 250 | [54] |
| | | | 2000 | 190 | |
| | | | 13000 | 130 | |
| | | | 15000 | 110 | |
| | | | 20000 | 80 | |
| | | | 22000 | 50 | |
| | | Purple | 13000 | 50 | [55] |
| | | | 8000 | 60 | |
| | | | 3000 | 60 | |
| Post-curing: | Triangle | Black | 100 | 100 | [56] |
| UV | | | 150 | 128 | |
| | | | 300 | 140 | |
| | | | 250 | 150 | |
| | | Red | 7500 | 1100 | [57] |
| | | | 7000 | 1000 | |
| | | | 4500 | 980 | |
| | | | 2900 | 880 | |
| | | | 1000 | 500 | |
| | | | 900 | 400 | |
| | | | 800 | 280 | |
| | | Blue | 1000 | 280 | [58] |
| | | | 500 | 320 | |
| | | Green | 130 | 150 | [59] |
| | | | 1000 | 267 | |
| | | | 3400 | 922 | |
| | | Yellow | 740 | 86 | [60] |
| | | Purple | 7500 | 570 | [61] |

TABLE 3
List of data points for Ashby plot in FIG. 13.

| | | Symbol | | | |
|---|---|---|---|---|---|
| | | color (i.e., | | | |
| | | Shaded; | | | |
| | | excludes | Young's | | |
| Printing | Symbol | empty | modulus | Extensibility | Reference |
| method | shape | circles) | (Pa) | (%) | number |
| In-situ | Square | Black | 390 | 200 | [62] |
| printing | | Red | 25000 | 120 | [63] |
| | | | 10000 | 150 | |
| | | | 4000 | 200 | |
| | | Blue | 50000 | 6.4 | [64] |
| | | | 63000 | 11.7 | |
| | | | 57000 | 11.8 | |
| | | Green | 60000 | 4 | [65] |
| | | Yellow | 25000 | 60 | [66, 67] |
| | | Purple | 640 | 1000 | [68] |
| | | | 1210 | 794 | |
| | | | 2370 | 461 | |
| | | | 3500 | 1587 | |
| | | | 2600 | 378 | |
| | | Cyan | 2000 | 100 | [69] |
| | | Orange | 1000 | 100 | [67, 70] |
| Post-curing: | Triangle | Black | 15000 | 60 | [71] |
| UV | | Red | 100000 | 1600 | [72] |
| | | Blue | 20000 | 200 | [67, 73] |
| | | Green | 3000 | 250 | [63, 67] |
| | | Yellow | 30000 | 50 | [74, 75] |
| | | Purple | 100000 | 600 | [76] |
| | | Cyan | 4000 | 150 | [75, 77] |
| | | Orange | 60000 | 100 | [67, 70] |

### Materials and Methods

Materials. MCR-M17, monomethacryloxypropyl terminated polydimethylsiloxane, average molar mass 5000 g/mol, was purchased from Gelest and purified using basic aluminum oxide columns to remove inhibitors. Benzyl methacrylate (96%), Copper(II) chloride (CuCl₂, 99.999%), Copper(II) bromide (CuBr₂, 99.999%), tris[2-(dimethylamino)ethyl]amine (Me₆TREN), ethylene bis(2-bromoisobutyrate (2-BiB, 97%), Tin(II) 2-ethylhexanoate (Sn(EH)₂, 92.5-100%), anisole (≥99.7%) and xylene (≥99.7%) were purchased from Sigma Aldrich and used as received. Toluene (Certified ACS), methanol (Certified ACS), diethyl ether (Certified ACS), dichloromethane (DCM, Certified ACS), dimethylformamide (DMF, Certified ACS), tetrahydrofuran (THF, Certified ACS) and THF (HPLC), were purchased from Fisher and used as received.

Polymer synthesis and characterization. To synthesize a linear-bottlebrush-linear triblock copolymer, we first synthesize the middle bottlebrush block, and then use the bottlebrush as a macro-initiator to grow the end linear blocks. For both steps, we use activator regenerated by electron transfer (ARGET) atom transfer radical polymerization (ATRP),^{[40]} as illustrated in FIG. 5.

Here, we describe the detailed synthesis protocol using sample S₅₀₀ as an example.

Step I. Synthesis of bottlebrush poly(dimethylsiloxane). A 50 mL Schlenk flask is charged with ethylene bis(2-bromoisobutyrate) (2f-BiB, 1.5 mg, 0.0042 mmol), MCR-M17 (10 g, 2 mmol), xylene (3.3 mL) and anisole (3.3 mL). We dissolve Me₆TREN (46 mg, 0.2 mmol) and CuBr₂ (4.5 mg, 0.02 mmol) in 1 mL dimethylformamide (DMF) to make a catalyst solution. Then, we add 30 μL catalyst solution, containing 6×10⁻³ mmol Me₆TREN and 6×10⁻⁴ mmol CuBr₂, to the mixture and bubble it with nitrogen for 60 mins to remove oxygen. Afterwards, the reducing agent, Sn (EH)₂ (12.2 mg, 0.03 mmol) in 200 μL xylene, is quickly added to the reaction mixture using a glass syringe. We seal the flask and then immerse it in an oil bath at 60° C. to start the reaction. We stop the reaction after 3 hours, and a small amount of mixture is taken out to determine the conversion using proton NMR (FIG. 6). From proton NMR, the conversion is 18.5% and the degree of polymerization is 112. This results in a bottlebrush polymer with the number average molecular weight of 560 kDa.

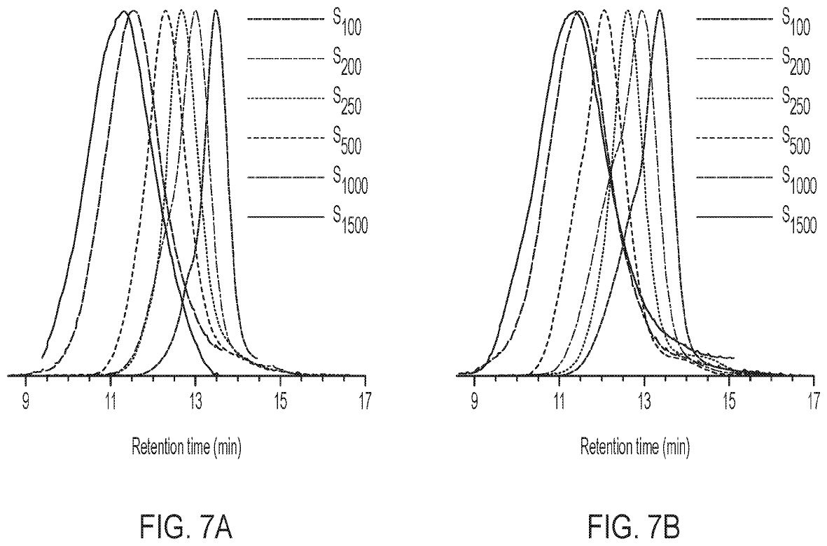

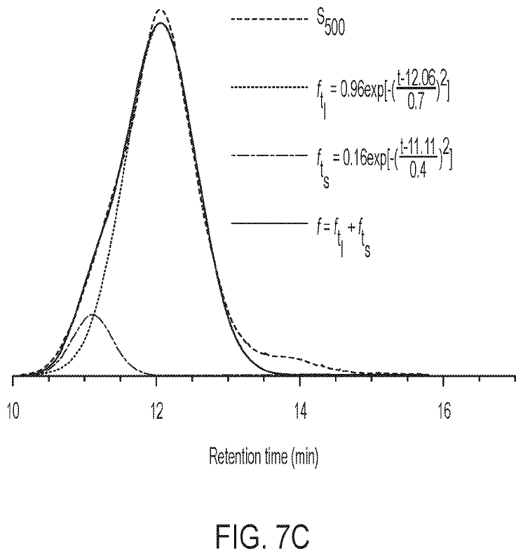

The rest reaction mixture is diluted with THF and passed through a neutral aluminum oxide column to remove the catalyst. The collected solution is concentrated by a rotary evaporator (Buchi R-205). To separate the bottlebrush polymer from the unreacted macromonomers, we create a co-solvent, a mixture of methanol and diethyl ether with a volume ratio 3:2, which is a good solvent for the macromonomers but not for the bottlebrush PDMS. After precipitation, we further centrifuge the mixture to separate the polymer from the solvent, re-dissolve the separated polymer in THF to make a homogenous solution. In an embodiment, the process repeats this precipitation procedure for five times to ensure that all unreacted macromonomers and impurities are completely removed. We use GPC to measure the PDI of the final product, which is 1.41 for this bbPDMS (FIG. 7(A)). At room temperature, the bbPDMS is a viscous, transparent liquid.

Step II. Synthesis of LBBL triblock copolymers. A 50 mL Schlenk flask is charged with benzyl methacrylate (BnMA, 906 mg, 5.14 mmol), macroinitiator (bbPDMS, 560 kDa, 1.34 g, 0.0024 mmol), xylene (3.9 mL) and anisole (2.6 mL). We dissolve Me₆TREN (46 mg, 0.2 mmol) and CuCl₂ (2.7 mg, 0.02 mmol) in 1 mL DMF to make a catalyst solution. We add 64 μL catalyst solution, containing 1.28′ 10-2 mmol Me₆TREN and 1.28×10⁻³ mmol CuCl₂, to the mixture and bubble it with nitrogen for 45 min to remove oxygen. Afterwards, reducing agent, Sn(EH)₂ (25.9 mg, 6.4×10⁻² mmol) in 200 μL xylene, is quickly added to the reaction mixture using a glass syringe. Then, we seal the flask and immerse it in an oil bath at 60° C. The reaction is stopped after 2 h. The reaction mixture is diluted in THF and passed through a neutral aluminum oxide column to remove the catalyst, and the collected solution is concentrated by a rotavapor. Instead of using a co-solvent as in Step I, we use methanol for precipitation for three times; this completely removes all unreacted monomers and impurities. After purification, the sample is dried in a vacuum oven (Thermo Fisher, Model 6258) at room temperature for 24 h. A small amount of the polymer is used for ¹H NMR analysis and GPC analysis. From ¹H NMR, the weight fraction is 6.4%, which indicates that the MW of PBnMA is about 19 kDa for each of the two end blocks. From GPC, the PDI is 1.52 for this triblock copolymer (FIG. 7(B)). At room temperature, the polymer is a transparent, elastic solid.

### SI Materials and Methods

¹H NMR characterization. ¹H NMR measurements are performed using Varian-600 MHz spectrometer. Chemical shifts for ¹H NMR spectra are reported in parts per million reference to a singlet at 7.26 ppm in CDCl₃. We use ¹H NMR to determine the number of side chains per bottlebrush and the weight fraction of PBnMA. The former one is calculated based on the conversion of PDMS macromonomers to bottlebrush PDMS, which is measured by the NMR spectra of the raw reaction mixture. The details of how to calculate the conversion of macromonomer in Step I can be found in a previous publication.^{[41]} Examples of ¹H NMR spectra of a bottlebrush PDMS and a triblock copolymer are shown in FIG. 6(A) and FIG. 6(B), respectively.

Here we describe how to use ¹H NMR to determine the number of side chains per bottlebrush and the weight fraction of PBnMA. For example, in FIG. 6(B), area a, A_{BnMA}, corresponds to the two H on the methylene group of benzyl methacrylate repeating unit. Area b, A_{PDMS}, corresponds to four H on the two carbon atoms connected with the silicon atom. The degree of polymerization of PBnMA and weight fraction of PBnMA can be calculated using:

$${DP}_{PBnMA} = \frac{{A}_{BnMA} / 2}{{A}_{PDMS} / 4} \times {DP}_{bbPDMS} \qquad ( 1 )$$

$$f = \frac{{DP}_{PBnMA} \times {MW}_{BnMA}}{{DP}_{bbPDMS} \times {MW}_{PDMS} + {DP}_{PBnMA} \times {MW}_{BnMA}} \qquad ( 2 )$$

For this synthesis, DP_{bbPDMS}=112, A_{BnMA}=3.90, and A_{PDMS}=4.00; thus, DP_{PBnMA}=218. Using this value and MW_{BnMA}=176.21 g/mol and MW_{PDMS}=5000 g/mol, one obtains f=0.064. And for each end of the two end blocks, MW_{PBzMA}=19 kg/mol.

Molecular weight distribution of polymers. We use gel permeation chromatography (GPC) to determine the polydispersity index (PDI) of polymers. GPC measurements are performed using TOSOH EcoSEC HLC-8320GPC system with two TOSOH Bioscience TSKgel GMH_{HR}-M 5 μm columns in series and a refractive index detector at 40° C. HPLC grade THF is used as the eluent with a flow rate of 1 mL/min. The calibration curve is obtained using standard polystyrene (PS) samples. The samples are dissolved in THF with a concentration around 3 mg/mL. The GPC data of all bbPDMS polymers and the corresponding LBBL polymers are shown in FIG. 7(A) and FIG. 7(B), respectively. The molecular weight and PDI of all samples are summarized in Table 1.

To further quantify the distribution of MW, we perform modality analysis for the LBBL triblock copolymers. We find that the retention profile of sample S₅₀₀ is well-described by a bimodal distribution, one minor peak with a shorter retention time at tₛ=11.11 min and the other major peak with a longer retention time at t₁=12.06 min, as shown in FIG. 7(C). Since the area under a monomodal distribution denotes the total mass of the polymer, the weight fraction of the larger MW component is about 8.7%.

To convert the weight fraction to number fraction, one needs to determine the relation between MW ratio and the retention time ratio. For GPC, the elution volume, or time t, is linearly proportional to the logarithmic of MW.^{[42]} Therefore, the MW of a polymer is:

$$M = a exp ( - t / {t}_{0} ) \qquad ( 3 )$$

where parameters a and t₀ are to be determined by column calibration. Because there are no GPC standards for LBBL polymers, we use other two LBBL polymer samples S₂₅₀ and S₁₅₀₀ with negligible shoulder peaks as the standards for calibration. The MW of middle block for these two LBBL polymers are about 250 kDa and 1500 kDa, respectively.

The average retention time is 12.61 min for S₂₅₀, and that for S₁₅₀₀ nm is 11.36 min. Considering the MW ratio is about 6, it gives t₀≈42 sec. Therefore, for the bimodal distribution of sample S₅₀₀, the MW ratio between the two peaks is:

$$\frac{{M}_{{t}_{s}}}{{M}_{{t}_{l}}} = exp ( - \frac{{t}_{s} - {t}_{ι}}{{t}_{0}} ) \approx 4 \qquad ( 4 )$$

The analysis (eq. 4) suggests that the average MW of the minor component is about four times of major component in the triblock copolymer. Because the weight fraction of the minor component is about 8.7%, the corresponding number fraction is about 2.5%. As a result, the error of characteristic lengths attributed to non-monomodal distribution of polymers, if any, is only 2.5%. Thus, we conclude that the non-monomodal distribution of LBBL polymers does not affect our conclusions in both microstructure and macroscopic mechanical properties.

Grazing-incidence small-angle scattering (GISAXS). GISAXS measurements are carried out using synchrotron source at the 12-ID beamline in Brookhaven National Laboratory. To prepare thin films with controlled, uniform thicknesses, we use dynamic spin coating during which a polymer solution is dropped onto a silicon substrate rotating at a prescribed speed. For example, the sample S₅₀₀ is dissolved in toluene with a concentration of 40 mg/mL. The polymer solution is purified by passing through a syringe filter with membrane pore size 0.45 μm. In parallel, a 1 cm×1 cm silicon wafer is loaded on a spin coater set with rotation per minute (RPM) of 2000 and spin time of 40 s. After reaching a stable RPM, we drop 30 μL polymer solution on the substrate. This results in a film of thickness 400 nm.

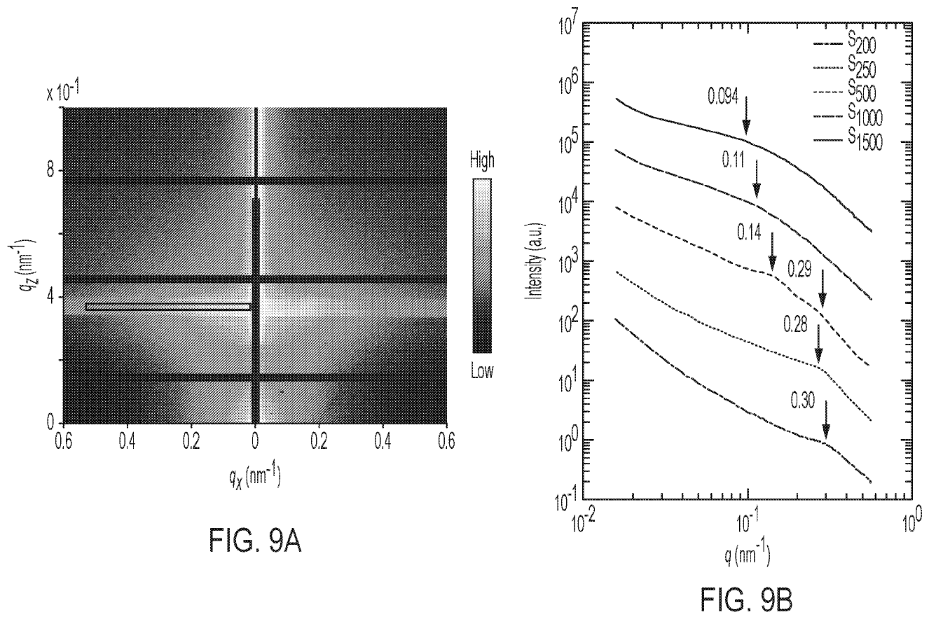

The experiments are conducted in reflection geometry using energy source of 13.9 keV. The distance between sample and detector is 8.3 m. An example of the scattered pattern and q map is shown in FIG. 9(A). We use GIXSGUI software to analyze the data,^{[43]} in which a region of interest (elongated-narrow hollow rectangle in FIG. 9(A)) is selected to calculate the dependence of intensity on the wavenumber, q, as shown in FIG. 9(B). For sample S₅₀₀, two characteristic peaks are identified. The peak with smaller q value representing the average domain distance between two neighboring spherical domains. The peak with large q value representing the average domain diameter. For other four samples, the q value representing the average domain distance. The domain distance and radius are calculated using d=2π/q. The information of average domain distance of five samples are listed in Table 1. The error corresponds to the half-width of the peak.

FIG. 1. Design concept of soft, 3D printable elastomers.

FIG. 1(A) schematically illustrates a responsive linear-bottlebrush-linear triblock copolymer.

FIG. 1(B) schematically illustrates at low temperature, the middle bottlebrush block (gray) act as elastic network strands, whereas the high T_{g} end linear blocks aggregate to form spherical glassy domains (black). The glassy domains dissociate at high temperature or in the presence of solvent, resulting in a solid-to-liquid transition of the network. The temperature/solvent triggered reversibility allows the elastomers for direct-write 3D printing.

FIG. 1(C) schematically illustrates that the glassy domains dissociate at high temperature or in the presence of solvent, resulting in a solid-to-liquid transition of the network. The temperature/solvent triggered reversibility allows the elastomers for direct-write 3D printing. In an embodiment, the printing process may be provided by a 3D printer 11 having a chamber 13 and a nozzle 15 that allows the elastomers 21 (in a solvent) to achieve the direct-write 3D printing to provide the network 31 (after the solvent evaporates).

FIG. 1(D) schematically illustrates that the side chain of the middle bottlebrush block is linear polydimethylsiloxane (PDMS), whereas the end blocks are linear poly(benzyl methacrylate) (PBnMA). A bottlebrush-based triblock polymer is denoted as BnMAₙ_{_{end}}-b-PDMSₙ_{_{BB}}^{w}-b-BnMAₙ_{_{end}} in which n_{end} is the number of repeating BnMA units, n_{BB} is the number of PDMS side chains per bottlebrush, and w represents the MW of PDMS side chains in kg/mol. The weight fraction of the end blocks in the triblock copolymer is kept below 6% to ensure that the bottlebrush-based ABA triblock copolymers self-assemble to a sphere phase.

FIG. 2. The self-assembled network is an optically transparent, soft, stretchable, and reversible elastomer.

FIG. 2(A) provides a depiction of an optical image of the elastomer self-assembled by sample S₅₀₀, BnMA₁₀₉-b-PDMS₁₁₂⁵-b-BnMA₁₀₉, with a molecular weight of nearly 500,000 g/mol.

FIG. 2(B) provides a micrographic depiction of a representative image of the elastomer characterized by hollow-cone dark field TEM without staining. The dark spherical dots are domains formed by PbnMA, whereas the white region is bbPDMS.

FIG. 2(C) graphically illustrates the GISAXS measurement for sample S₅₀₀ that reveals a characteristic peak at the wavenumber of q=0.14 nm⁻¹.

FIG. 2(D) graphically illustrates the frequency dependence of the storage (solid line circles, G′) and loss (dashed line circles, G″) moduli of the soft elastomer measured at 20° C. at a fixed strain of 0.5%. The measured stiffness 6 kPa is consistent with the theoretical prediction for an unentangled polymer network: G≈k_{B}Tρ/M=4350 Pa, where k_{B} is Boltzmann constant. T=293K is the absolute temperature, M=560,000 g/mol is the mass of the triblock copolymer, and ρ≈1 g/cm³ is density of PDMS.

FIG. 2(E) graphically illustrates the large amplitude oscillatory shear measurements of the elastomer at 20° C. at a fixed frequency of 1 rad/sec. Above the shear fracture strain, γ_{y}, of 1.66, the G″ becomes larger than G′.

FIG. 2(F) graphically illustrates the dependence of the viscoelastic properties on temperature from −20° C. to 180° C. at a fixed strain of 5% and an oscillatory frequency of 1 rad/sec.

FIG. 2(G) graphically illustrates the elastomer that is mixed with dichloromethane at a volume ratio of 1:2, the mixture is a yield stress fluid that transitions from solid-like to liquid-like at shear stresses above 70 Pa.

FIG. 3. Direct-write printing soft elastomers to create deformable 3D structures.

FIG. 3(A) provides a photographic depiction of a 3D printed UVA logo with a stack thickness of 2 mm. Upper: bird's eye view; lower: side view.

FIG. 3(B) provides a photographic depiction of a free-standing, 3D printed letter ‘A’.

FIG. 3(C) provides a photographic depiction of a 3D rendering of a cubic gyroid (left) 33 and the corresponding printed product with dimension 10×10×10 mm³ (right) 33.

FIG. 3(D) graphically illustrates that for the bulk sample, the compression-release profile exhibits a hysteresis associated with 23% energy dissipation (bolded lines, i.e. upper two lines rendered in graph), whereas for the gyroid there is almost no energy dissipation, as evidenced by the complete overlap between the compression and release profiles (non-bolded lines, i.e. lower two lines rendered in graph nearly overlapping one another). The apparent Young's modulus, Y=σ/ϵ, of the gyroid is about 8 kPa, nearly a half of 20 kPa for the bulk; this is likely because that the porous gyroid has a lower density about ½ of the bulk. The strain rate is 0.005/sec. Error bar: standard deviation for n 5.

FIG. 3(E) graphically illustrates that the compression strain increases from 0.2 to 0.55, the bulk sample exhibits strain-stiffening with the compression stress increasing from 8 to 130 kPa. and further compression with ϵ>0.55 results in materials fracture (optical images). The stress-strain profile is used to calibrate FEA simulation (dashed line).

FIG. 3(F) graphically illustrates that the cubic gyroid exhibits a nearly linear elastic deformation up to ϵ=0.35, at which the stress is about 5 kPa, 10 times lower than the 50 kPa for the bulk. Slightly above ϵ=0.35, the stress exhibits a sharp decrease (solid line).

FIG. 3(G) schematically illustrates that the decrease in stress is associated with structural collapse of the gyroid, as indicated by comparing the snapshots from FEA simulation (dashed line in f and upper panel) with the optical images of the gyroid (lower panel) under various extents of compression.

FIG. 4. Mechanical properties of 3D printable elastomers.

FIG. 4(A) graphically illustrates the dependence of shear fracture strain, γ_{y}, on the shear modulus, G, of bottlebrush-based elastomers. Solid filled circles: elastomers formed by the self-assembly of PbnMA-bbPDMS-PbnMA triblock copolymers; empty [white filled] squares: elastomers formed by chemically crosslinking precursor linear bottlebrush PDMS polymers in a melt (data from ref. 32). Solid line (descending): the theoretical prediction for the shear fracture strain of the chemically crosslinked bottlebrush polymer networks given by γ_{y}=Lₘₐₓ/R−1, in which Lₘₐₓ and R are respectively the contour length and end-to-end distance of the bottlebrush polymer between two neighboring crosslinks. Both Lₘₐₓ and R are determined by shear modulus G with details provided in ref. 32.

FIG. 4(B) graphically illustrates an Ashby plot of 3D printable elastomers based on extensibility (shear fracture strain or elongation at break) and Young's modulus. Solid-filled circles grouped with the caption as “In-situ printing: this work” are our ultrasoft elastomers. The symbols grouped with captions “In-situ printing,” “Post-curing: Light,” and “Post-curing: Temperature” represent existing 3D printable elastomers (Table 2). The printed elastomeric structures can be solidified in situ or require post-curing: shaded or empty [white filled] circles (i.e., not solid circles)—post-curing by heat; triangles—post-curing by UV light; squares—thermoplastic elastomers.

FIG. 5 schematically illustrates the synthesis procedure of bottlebrush and linear-bottlebrush-linear (LBBL) triblock copolymers.

Step I: synthesis of bottlebrush poly(dimethylsiloxane) (bbPDMS) using ARGET ATRP of macromonomer monomethacryloxypropyl terminated polydimethylsiloxane.

Step II: synthesis of LBBL polymer through ARGET ATRP of benzyl methacrylate (BnMA).

FIG. 6. ¹H nuclear magnetic resonance (NMR) spectra of bbPDMS and LBBL polymers.

FIG. 6(A) graphically illustrates the ¹H NMR spectrum of bottlebrush PDMS with molecular weight 560 k g/mol. ¹H NMR (600 MHz, CDCl₃) δ (ppm) 3.88 (m, —CO—O—CH₂—CH₂—CH₂—Si(CH₃)₂—O—), 1.62 (m, —CH₂—C(CH₃)(CH₂—)—CO—O—), 1.58 (m, —CO—O—CH₂—CH₂—CH₂—Si(CH₃)₂—O—), 1.32-1.31 (m, —O—Si(CH₃)₂—CH₂—CH₂—CH₂—CH₃), 1.05 and 0.59 (m, —CH₂—C(CH₃)(CH₂—)—CO—O—), 0.89-0.87 (—O—Si(CH₃)₂—CH₂—CH₂—CH₂—CH₃), 0.55-0.52 (m, —CH₂—(—Si(CH₃)₂—O—), —Si(CH₃)₂—CH₂—CH₂—CH₂—CH₃), 0.16-0.03 (m, —CH₂—(—Si(CH₃)₂—O—)ₙ—Si(CH₃)₂—CH₂—CH₂—CH₂—CH₃).

FIG. 6(B) graphically illustrates the ¹H NMR spectrum of LBBL triblock copolymer with middle block 560 kg/mol and weight fraction of PBnMA 6.4%. ¹H NMR (600 MHz, CDCl₃) δ (ppm) 7.27 (m, —CO—O—CH₂-Ph, H on phenyl ring), 5.01-4.86 (m, —CO—O—CH₂-Ph), 3.86 (m, —CO—O—CH₂—CH₂—CH₂—Si(CH₃)₂—O—), 1.94-1.60 (m, —CH₂—C(CH₃)(CO—O—CH₂—CH₂—CH₂—Si(CH₃)₂—O—)— and —CH₂—C(CH₃)(CO—O—CH₂-Ph)-) 1.60 (m, —CO—O—CH₂—CH₂—CH₂—Si(CH₃)₂—O—), 1.32-1.31 (m, —O—Si(CH₃)₂—CH₂—CH₂—CH₂—CH₃), 0.91 and 0.73 (m, —CH₂—C(CH₃)(CO—O—CH₂—CH₂—CH₂—Si(CH₃)₂—O—)— and —CH₂—C(CH₃)(CO—O—CH₂-Ph)-), 0.89-0.87 (—O—Si(CH₃)₂—CH₂—CH₂—CH₂—CH₃), 0.55-0.52 (m, —CH₂—(—Si(CH₃)₂—O—)ₙ—Si(CH₃)₂—CH₂—CH₂—CH₂—CH₃), 0.17-0.03 (m, —CH₂—(—Si(CH₃)₂—O—)ₙ—Si(CH₃)₂—CH₂—CH₂—CH₂—CH₃).

FIG. 7. Gel permeation chromatography (GPC) of all bbPDMS and LBBL polymers.

FIG. 7(A) graphically illustrates the GPC trace of all bbPDMS polymers.

FIG. 7(B) graphically illustrates the GPC trace of all LBBL triblock copolymers.

FIG. 7(C) graphically illustrates the modality analysis of sample S₅₀₀ reveals a bimodal distribution. The larger component (shortest curve as denoted by the long dash-short dash line) has a weight fraction of 8.7%, equivalent to a number fraction of 2.5%.

FIG. 8. Quantification of the characteristic length scales of ultrasoft elastomers.

FIG. 8(A) graphically illustrates an example distribution of the domain distance d.

FIG. 8(B) graphically illustrates an example distribution of the domain radius r based on TEM images of sample S₅₀₀ (FIG. 2b); d=49.2±4.7 nm, and r=10.2±1.2 nm.

FIG. 9. Characterization of the microstructure of ultrasoft elastomers.

FIG. 9(A) graphically illustrates an example of a scattering intensity map for sample S₅₀₀ measured by GISAXS. The elongated-narrow hollow rectangle is the region of interest for analysis using GIXSGUI software.

FIG. 9(B) graphically illustrates the decay of the scattering intensity vs. the wavenumber q for elastomers assembled by LBBL polymers of different molecular weight

FIG. 10. Effects of temperature on the microstructure and mechanical properties of the elastomer.

FIG. 10(A) graphically illustrates the in situ GISAXS measurements reveal characteristic scattering peaks at the fixed wavenumber up to 180° C. However, the peaks disappear at the melting point, 200° C., of the glassy domains.

FIG. 10(B) graphically illustrates the dependence of shear modulus on temperature. The shear modulus is taken as the value of G′ at the lowest oscillatory shear frequency 0.1 rad/sec.

FIG. 10(C) graphically illustrates the storage (solid line, G′) and loss (dash line, G″) moduli of sample S₅₀₀ measured at a fixed strain of 0.5%. For this elastomer, a master curve cannot be obtained using classic time-temperature superposition.

FIG. 11 graphically illustrates that the ultrasoft elastomers are 100% solvent reprocessable.

FIG. 11 graphically illustrates the storage (dashed line symbols, G′) and loss (solid line symbols, G″) moduli of sample S₅₀₀ measured at a fixed strain of 0.5% at the temperature of 20° C. before and after solvent reprocessing using DCM.

FIG. 12. Dependence of stiffness and extensibility on molecular weight of LBBL polymers.

FIG. 12(A) graphically illustrates that all samples are elastomers except for S₁₀₀, which has a molecular weight of 100 kDa and is liquid-like. This is because the MW of the end linear blocks 3000 g/mol is too small to form hard glassy domains. Solid lines, storage moduli G′; dashed lines, loss moduli G″. Measurements are performed at 0.5% strain and 20° C.

FIG. 12(B) graphically illustrates the large amplitude oscillatory shear measurements are performed at 1 rad/sec for all samples. The shear fracture strain increases when the elastomers become softer.

FIG. 12(C) graphically illustrates the dependence of shear modulus (circles) on the molecular weight of the bottlebrush middle block.

FIG. 13 graphically illustrates an Ashby plot for the extensibility and the Young's moduli of existing 3D printable hydrogels and our ultrasoft elastomers. Empty [white filled] circles are ultrasoft reversible elastomers. Square and triangle symbols are existing 3D printable hydrogels listed in Table 3.

### EXAMPLES AND EXPERIMENTAL RESULTS

Practice of an aspect of an embodiment (or embodiments) of the invention will be still more fully understood from the following experimental results, which are presented herein for illustration only and should not be construed as limiting the invention in any way.

### Experimental Results Set No. 1

### Transmission Electron Microscopy (TEM) Characterization

We use TEM to characterize the morphology of said elastomers. To ensure that the self-assembled microstructure is an equilibrium configuration, we use solvent-annealing to prepare the samples, during which the evaporation of the solvent is controlled at a slow rate. Specifically, a LBBL polymer sample is dissolved in toluene with a concentration of 5 mg/mL. The polymer solution is purified by passing through a syringe filter with pore size 0.45 μm. Then, 10 μL polymer solution is added to a carbon film coated copper TEM grid, which is placed on a 1 mm thick glass cover slide in a glass Petri dish partially filled with toluene. We cover the Petri dish with a glass lid to allow the solvent to slowly evaporate at room temperature for 36 h. The annealed sample is characterized using hollow-cone dark-field TEM (FEI Titan) at the electron energy of 300 keV, and a representative image of sample S₅₀₀ is shown in FIG. 6(B). We use TEM images to calculate the PBnMA domain radius and the distance between the centers of neighboring PBnMA domains. The histograms of domain distance, (d), and domain radius, (r), of sample S₅₀₀ are shown in FIGS. 8(A) and 8(B). The average domain distance is 49.2±4.7 nm; the average domain radius is 10.2±1.2 nm.

### Experimental Results Set No. 2

### Grazing-Incidence Small-Angle Scattering.

GISAXS measurements are carried out using synchrotron source at the 12-ID beamline in Brookhaven National Laboratory. The details of sample preparation and measurements are described in the Materials and Methods Section. The scattering results for all samples are shown in FIG. 9, and the average domain distances are listed in Table 1.

### Experimental Results Set No. 3

### Bulk Rheology

Rheological measurements are performed using a stress-controlled rheometer (Anton Paar MCR 302) equipped with a plate-plate geometry of diameter 25 mm. We dissolve LBBL polymers in DCM at a volume ratio of 1:2 to make a homogenous mixture. We pipette about 1 mL solution onto the bottom plate, allow the solution to dry in the air at room temperature, and then heat the bottom plate to 40° C. for an additional 20 min. This allows us to prepare a dried, relatively thick film, ˜0.3 mm, yet without the formation of cavities due to the evaporation of solvent. Then, we lower the upper plate and trim the excess sample at the edge of the geometry.

For frequency sweep, we fix the temperature at 20° C. and the oscillatory shear strain at 0.5% while varying the shear frequency from 0.1 rad/sec to 10 rad/sec. For strain sweep, we fix the temperature at 20° C. and the oscillatory frequency at 1 rad/sec while increasing the shear strain from 1% to 1000%. For temperature sweep, we fix the oscillatory frequency at 1 rad/s and the shear strain at 5% while increasing the temperature from −20° C. to 180° C.

To characterize the yield stress behavior, we transfer the polymer mixture on the bottom plate and lower the upper plate to reach 0.8 mm gap distance. Then, we add deionized water to the side of the solution to prevent the solvent evaporation. The density of DCM, 1.33 g/cm³, is higher than water, and therefore this prevents convection induced mixing. During the measurement, we fix the temperature at 20° C. and the oscillatory frequency at 1 Hz while increasing the shear stress from 1 to 160 Pa.

To demonstrate the reprocessability of the self-assembled elastomers, we re-dissolve the elastomer in DCM, and re-dry the solution to obtain an elastomer. The solvent-reprocessed elastomer exhibits negligible changes in mechanical properties, as shown by FIG. 11.

### Experimental Results Set No. 4

### Direct-Write Printing

To print the soft elastomers, we modify a fused deposition modeling printer (JGAURORA Z-603S, China) by replacing the printhead with a solution extrusion module. We load the stress yield polymer mixture in a 5 mL gastight glass syringe equipped with a dispensing needle of an inner diameter 0.25 mm. The G-code and printing speed is generated and optimized using slicing software Cura 14.07.

### Experimental Results Set No. 5

### Compression Test

Because our elastomers are extremely soft, the force required to deform the material is very small. To this end, we use a rheometer (Anton Paar MCR 302) with a normal force resolution of 0.5 mN to perform the compression tests. The sample, in the form of either a bulk material or a printed cubic gyroid, is fixed onto the bottom geometry. We lower the upper geometry to contact with the sample, at which the normal force is slightly above zero. During the compression measurements, the moving profile of the upper plate is pre-setup to exert cyclic and subsequent large compression at a fixed strain rate 0.005/sec. We record the normal force, gap size, and time, and calculate the stress and strain based on the pre-measured dimension of the samples.

### Experimental Results Set No. 6

### Finite Element Analysis (FEA)

Using the ABAQUS/Standard package, we perform FEA simulation to model the response of 3D printed features under a quasi-static compression. The elastomer is described by the Neo Hooke model, in which the strain energy density W is given by

$$W = {C}_{10} ( {I}_{1} - 3 ) + \frac{1}{{D}_{1}} {( J - 1 )}^{2} ,$$

where l₁ is the first strain invariant and J is the elastic volume ratio which is defined by J=λ₁λ₂λ₃. λᵢ (i=1,2,3) are the principal stretches. We calibrate the simulation by comparing it to the bulk sample (FIG. 3(E)); this gives C₁₀=1.36×10⁻², and D₁=0.32. These parameters are used to simulate the gyroid, which is modeled by 24,000 four-node tetrahedral (C3D4) elements. For both the bulk and the gyroid, two rigid plates are added at two sides of a sample with a friction coefficient set to be 0.1.

### Additional Examples

Example 1. A triblock copolymer comprising: a linear polymer wherein said linear polymer creates glassy domains within said triblock copolymer, and a bottlebrush polymer, wherein said bottlebrush polymer connects said glassy domains.

Example 2. A triblock copolymer comprising: a linear polymer, wherein said linear polymer is poly(benzyl methacrylate); and a bottlebrush polymer, wherein said bottlebrush polymer is comprised of polydimethylsiloxane side chains, wherein said bottlebrush polymer is situated between two of said linear polymers.

Example 3. A method of making a triblock copolymer, comprising: synthesizing a bottlebrush polymer; and adding one or more of said linear polymer to said bottlebrush polymer to yield said triblock copolymer.

Example 4. The method of example 3, wherein said synthesizing of said bottlebrush polymer is via free radical polymerization.

Example 5. The method of example 4, wherein synthesizing is via atom transfer radical polymerization (ATRP).

Example 6. The method of example 4 (as well as subject matter in whole or in part of example 5), wherein said atom transfer radical polymerization (ATRP) is activator regenerated electron transfer (ARGET), initiators for continuous activator regeneration (ICAR ATRP), supplemental activator and reducing agent (SARA ATRP), and electrochemically mediated ATRP.

Example 7. The method in example 3 (as well as subject matter of one or more of any combination of examples 4-6, in whole or in part), wherein starting materials of said bottlebrush polymer are ethylene bis(2-bromoisobutyrate) and monomethacryloxypropyl terminated polydimethylsiloxane.

Example 8. The method in example 3 (as well as subject matter of one or more of any combination of examples 4-7, in whole or in part), wherein said synthesizing includes a catalyst solution.

Example 9 The method of example 8, wherein said catalyst solution is comprised of. Me₆TREN and CuBr₂; Me₆TREN and CuCl₂; or Me₆TREN, CuCl₂ and CuBr₂.

Example 10. The method of claim 8 (as well as subject matter in whole or in part of example 9), further comprising removing oxygen after said synthesis.

Example 11. The method of claim 10, further comprising adding a reducing agent.

Example 12. The method of example 11, wherein said reducing agent is: Sn(EH)₂ in xylene or Sn(EH)₂ in toluene.

Example 13. The method of claim 3 (as well as subject matter of one or more of any combination of examples 4-12, in whole or in part), further comprising heating during said synthesis and said addition of said one or more of said linear polymer.

Example 14. The method of example 13, where said heating is in the range of about 50 to about 70 degrees Celsius.

Example 15. The method of example 3 (as well as subject matter of one or more of any combination of examples 4-14, in whole or in part), wherein said synthesizing of said triblock copolymer is via free radical polymerization.

Example 16. The method of example 15, wherein synthesizing is via atom transfer radical polymerization (ATRP).

Example 17. The method of example 15 (as well as subject matter in whole or in part of example 16), wherein said atom transfer radical polymerization (ATRP) is activator regenerated electron transfer (ARGET), initiators for continuous activator regeneration (ICAR ATRP), supplemental activator and reducing agent (SARA ATRP), and electrochemically mediated ATRP.

Example 18. The method in example 15 (as well as subject matter of one or more of any combination of examples 16-17, in whole or in part), wherein starting materials are benzyl methacrylate, and a macroinitiator.

Example 19. The method in example 15 (as well as subject matter of one or more of any combination of examples 16-18, in whole or in part), wherein said synthesizing includes a catalyst solution.

Example 20. The method of example 15 (as well as subject matter of one or more of any combination of examples 16-19, in whole or in part), wherein said catalyst solution is comprised of: Me₆TREN and CuBr₂; Me₆TREN and CuCl₂; or Me₆TREN, CuCl₂ and CuBr₂.

Example 21. The method of claim 15 (as well as subject matter of one or more of any combination of examples 16-20, in whole or in part), further comprising removing oxygen after said synthesizing.

Example 22. The method of claim 21, further comprising a reducing agent.

Example 23. The method of example 22, wherein said reducing agent is Sn(EH)₂ in xylene or Sn(EH)₂ in toluene.

Example 24. The method of claim 15 (as well as subject matter of one or more of any combination of examples 16-23, in whole or in part), further comprising heating during said synthesis and said addition of said one or more of said linear polymer.

Example 25. The method of example 24, where said heating is in the range of about 50 to about 70 degrees Celsius.

Example 26. The method of example 24, where said heating is in the range of about 60 degrees Celsius.

Example 27. A polymer network comprising a plurality of triblock copolymers, wherein: said bottlebrush polymers configured to operate as elastic network strands; and said linear polymers aggregate to form spherical glassy domains.

Example 28. The polymer network of example 27, wherein said spherical glassy domains engage in a dissociation at high temperature or in the presence of solvent, resulting in a solid-to-liquid transition of the network.

Example 29. The polymer network of example 28, wherein said dissociation is reversible.

Example 30. An article comprising the polymer network of example 27 (as well as subject matter of one or more of any combination of examples 28-29, in whole or in part).

Example 31. The article of example 30, wherein said article is a solvent-free elastomer.

Example 32. The article of example 30 (as well as subject matter in whole or in part of example 31), wherein said article is a gyroid.

Example 33. The article of example 30 (as well as subject matter of one or more of any combination of examples 31-32, in whole or in part), wherein said article exhibits an extensibility up to 600%.

Example 34. The article of example 30 (as well as subject matter of one or more of any combination of examples 31-33, in whole or in part), wherein said article has a Young's modulus minimum of about 100 Pa.

Example 35. The article of example 30 (as well as subject matter of one or more of any combination of examples 31-34, in whole or in part), wherein said article is thermostable between the temperatures of about −125° C. and about 180° C.

Example 36. The article of example 30 (as well as subject matter of one or more of any combination of examples 31-35, in whole or in part), wherein said article is 3D printable.

Example 37. The article of example 30 (as well as subject matter of one or more of any combination of examples 31-36, in whole or in part), wherein said article contributes structurally to a medical device.

Example 38. The article of example 37, wherein said medical device is implantable.

Example 39. The article of example 30 (as well as subject matter of one or more of any combination of examples 31-38, in whole or in part), wherein said article constitutes a portion of a vocal cord prosthesis apparatus.

Example 40. The article of example 30 (as well as subject matter of one or more of any combination of examples 31-39, in whole or in part), wherein said article constitutes a permanent filler for vesicoureteral reflux.

Example 41. A method for synthesizing a polymer network of said triblock copolymers of example 27 (as well as subject matter of one or more of any combination of examples 28-40, in whole or in part) comprising removing solvent.

Example 42. A method for 3D printing an elastomer, comprising: adding a solvent to polymer network at a specified pressure in a chamber of a 3D printer apparatus; transferring said polymer network with said solvent from a printer nozzle of said 3D printer apparatus; and wherein said solvent evaporates after exiting said nozzle and the glassy domains of said polymer network reassociate.

Example 43. A method of manufacturing any one or more of the composites or articles in any one or more of Examples 1, 2, and 27-40.

Example 44. A method of using any one or more of the composites or articles in industry in any one or more of Examples 1, 2, and 27-40.

Example 45. An article of manufacture produced by any one or more of the methods in any one or more of Examples 3-26 and 41-42.

Example 46. One or more systems configured for applying the methods in any one or more of Examples 3-26 and 41-42.

Example 47. An article of manufacture produced by any one or more of the systems in Example 46.

### REFERENCES

The devices, systems, apparatuses, modules, compositions, materials, computer program products, non-transitory computer readable medium, and methods of various embodiments of the invention disclosed herein may utilize aspects (such as devices, apparatuses, modules, systems, compositions, materials, computer program products, non-transitory computer readable medium, and methods) disclosed in the following references, applications, publications and patents and which are hereby incorporated by reference herein in their entirety (and which are not admitted to be prior art with respect to the present invention by inclusion in this section):
[1] R. L. Truby, J. A. Lewis, Nature 2016, 540, 371.
[2] S. Gantenbein, K. Masania, W. Woigk, J. P. W. Sesseg, T. A. Tervoort, A. R. Studart, Nature 2018, 561, 226.
[3] D. Oran, S. G. Rodriques, R. Gao, S. Asano, M. A. Skylar-Scott, F. Chen, P. W. Tillberg, A. H. Marblestone, E. S. Boyden, Science 2018, 362, 1281.
[4] B. E. Kelly, I. Bhattacharya, H. Heidari, M. Shusteff, C. M. Spadaccini, H. K. Taylor, Science 2019, 363, 1075.
[5] S. C. Ligon, R. Liska, J. Stampfl, M. Gurr, R. Mitlhaupt, Chem. Rev. 2017, 1/7, 10212.
[6] J. R. Tumbleston, D. Shirvanyants, N. Ermoshkin, R. Janusziewicz, A. R. Johnson, D. Kelly, K. Chen, R. Pinschmidt, J. P. Rolland, A. Ermoshkin, E. T. Samulski, J. M. DeSimone, Science 2015, 347, 1349.
[7] D. A. Walker, J. L. Hedrick, C. A. Mirkin, Science 2019, 364, 1.
[8] M. A. Skylar-Scott, J. Mueller, C. W. Visser, J. A. Lewis, Nature 2019, 575, 330.
[9] T. J. Hinton, A. Hudson. K. Pusch, A. Lee, A W. Feinberg, ACS Biomater. Sci. Eng. 2016, 2, 1781.
[10] D. K. Patel, A. H. Sakhaei, M. Layani, B. Zhang, Q. Ge, S. Magdassi, Adv. Mater. 2017, 29, 1606000.
[11] P. J. Scott, V. Meenakshisundaram, M. Hegde, C. R. Kasprzak, C. R. Winkler, K. D. Feller, C. B. Williams, T. E. Long, ACS Appl. Mater. Interlaces 2020, 12, 10918.
[12] D. B. Kolesky, R. L. Truby, A. S. Gladman, T. A. Busbee, K. A. Homan, J. A. Lewis, Adv. Mater. 2014, 26, 3124.
[13] A. Lee, A. R. Hudson, D. J. Shiwarski, J. W. Tashman, T. J. Hinton, S. Yemeni, J. M. Bliley, P. G. Campbell, A. W. Feinberg, Science 2019, 365, 482.
[14] J. T. Muth, D. M. Vogt, R. L. Truby, D. B. Kolesky, R. J. Wood, J. A. Lewis, Adv. Mater. 2014, 26, 6307.
[15] A. Kotikian, R. L. Truby, J. W. Boley, T. J. White, J. A. Lewis, Adv. Mater. 2018, 30, 1.
[16] M. Schaffner, J. A. Faber, L. Pianegonda, P. A. Riihs, F. Coulter, A. R. Studart, Nat. Commun. 2018, 9, 1.
[17] Y. Kim, H. Yuk, R. Zhao, S. A. Chester, X. Zhao, Nature 2018, 558, 1.
[18] M. O. Saed, C. P. Ambulo, H. Kim, R. De, V. Ra-val, K. Searles. D. A. Siddiqui, J. M. O. Cue, M. C. Stefan, M. R. Shankar, T. H. Ware, Adv. Flunct. Mater. 2019, 29, 1.
[19] X. Kuang, K. Chen, C. K. Dunn, J. Wu, V. C. F. Li, H. J. Qi, ACS Appl. Mater. Interfaces 2018, 10, 7381.
[20] E. C. Davidson, A. Kotikian, S. Li, J. Aizenberg, J. A. Lewis, Adv. Mater. 2020, 32, 1905682.
[21] Levental, P. C. Georges. P. A. Janmey, Soft Matter 2007.3, 1.
[22] S. V Murphy, A. Atala, Nat. Biotechnol. 2014, 32, 773.
[23] H. Yuk, B. Lu, X. Zhao, Chem. Soc. Rev. 2019, 48, 1642.
[24] Y. S. Zhang, A. Khademhosseini, Science 2017, 356, eaaf3627.
[25] J. J. Paturej, S. S. Sheiko, S. Panyukov, M. Rubinstein, Sci. Adv. 2016, 2, e1601478.
[26] M. Vatankhah-Vamosfaderani, A. N. Keith, Y. Cong, H. Liang. M. Rosenthal, M. Sztucki, C. Clair, S. Magonov, D. A. Ivanov, A. V Dobrynin, S. S. Sheiko, Science 2018, 359, 1509.
[27] S. Nian, H. Lian. Z. Gong, M. Zhernenkov, J. Qin, L.-H. Cai, ACS Macro Lett. 2019, 8, 1528.
[28] L. H. Cai, T. E. Kodger, R. E. Guerra, A. F. Pegoraro, M. Rubinstein, D. A. Weitz, Adv. Mater. 2015, 27, 5132.
[29] J. E. Mark, Physical Properties of Polymers Handbook, Springer Science & Business Media, 2007.
[30] F. S. Bates, G. H. Fredrickson, Annu. Rev. Phys. Chem. 1990, 41, 525.
[31] M. Rubinstein, R. H. Colby, Polymer Physics, Oxford University Press, Oxford, U K, 2003.
[32] L.-H. Cai, Soft Matter 2020, DOI 10.1039/D0SM00759E.
[33] K. Hyun, M. Wilhelm, C. O. Klein, K. S. Cho, J. G. Nam, K. H. Ahn. S. J. Lee, R. H. Ewoldt. G. H. McKinley, Prog. Polym. Sci. 2011, 36, 1697.
[34] J. G. Drobny, Handbook of Thermoplastic Elastomers: Second Edition, William Andrew, 2014.
[35] Y. L. Chen, A. M. Kushner, G. A. Williams, Z. B. Guan, Nat. Chem. 2012, 4, 467.
[36] C. B. Highley, C. B. Rodell, J. A. Burdick, Adv. Mater. 2015, 27, 5075.
[37] T. Jungst, W. Smolan, K. Schacht, T. Scheibel, J. Groll, Chem. Rev. 2016, 116, 14%.
[38] E. Sidfert, E. Reyssat, J. Bico, B. Roman, Nat. Mater. 2019, 18, 24.
[39] M. R. Bockstaller, R A. Mickiewicz, E. L. Thomas, Adv. Mater. 2005, 17, 1331.
[40] K. Matyjaszewski, W. Jakubowski, K. Min, W. Tang, J. Huang, W. A. Braunecker, N. V Tsarevsky, Proc. Natl. Acad Sci. 2006, 103, 15309.
[41] S. Nian, H. Lian, Z. Gong, M. Zhemenkov, J. Qin, L. Cai, ACS Macro Lett. 2019, 8, 1528.
[42] A. Striegel, W. W. Yau, J. J. Kirkland, D. D. Bly, Modern Size-Exclusion Liquid Chromatography: Practice of Gel Permeation and Gel Filtration Chromatography, John Wiley & Sons, 2009.
[43] Z. Jiang, J. Appl. Crystallogr. 2015, 48, 917.
[44] M. Vasquez, J. Cross, N. Hopkinson, B. Haworth, Procedia Eng. 2012, 34, 325.
[45] J. Mo, J. Kang, S. Shin, J. Jegal, H. Gil, S. Choy, M. Hakkarainen, J. Park, D. X. Oh, S. Yeon, Compos. Sci. Technol. 2020, 185, 107885.
[46] H. Sun, Z. Han, N. Willenbacher, ACS Appl. Mater. Interfaces 2019, 11, 38092.
[47] N. Kumar, P. K. Jain, P. Tandon, P. M. Pandey, J. Manuf. Process. 2018, 35, 317.
[48] A. D. Valentine, T. A. Busbee, J. W. Boley, J. R. Raney, A. Chortos, A. Kotikian, J. D. Berrigan, M. F. Durstock, J. A. Lewis, Adv. Mater. 2017, 29, 1703817.
[49] X. Hu, H. Kang, Y. Li, Y. Geng, R. Wang, L. Zhang, Polymer 2017, 108, 11.
[50] J. T. Muth, D. M. Vogt, R L. Truby, D. B. Kolesky, R. J. Wood, J. A. Lewis, Adv. Mater. 2014, 26, 6307.
[51] Y. Park, C. Majidi, R. Kramer, B. Phillipe, R. J. Wood, J. Micromechanics Microengineering 2010, 20, 125029.
[52] L. Zhou, Q. Gao, J. Fu, Q. Chen, J. Zhu, Y. Sun, ACS Appl. Mater. Interfaces 2019, 11, 23573.
[53] M. M. Durban, J. M. Lenhardt, A. S. Wu, W. S. Iv, T. M. Bryson, L. Perez-perez, D. T. Nguyen, S. Gammon, J. E. Smay, E. B. Duoss, J. P. Lewicki, T. S. Wilson, Macromol. Rapid Commun. 2018, 39, 1700563.
[54] A. Chortos, E. Hajiesmaili, J. Morales, D. R. Clarke, J. A. Lewis, Adv. Funct. Mater. 2020, 30, 1907375.
[55] K. Chen, L. Zhang, X. Kuang, V. Li, M. Lei, G. Kang, Z. L. Wang, H. J. Qi, Adv. Funct. Mater. 2019, 29, 1903568.
[56] H. Xiang, X. Wang, Z. Ou, G. Lin, J. Yin, Z. Liu, Prog. Org. Coatings 2019, 137, 105372.
[57] D. K. Patel, A. H. Sakhaei, M. Layani, B. Zhang, Q. Ge, Adv. Mater. 2017, 29, 1606000.
[58] E. C. Davidson, A. Kotikian, S. Li, J. Aizenberg, J. A. Lewis, Adv. Mater. 2020, 32, 1905682.
[59] M. Schaffner, J. A. Faber, L. Pianegonda, P. A. Rühs, F. Coulter. A. R. Studart, Nat. Commun. 2018, 9, 1.
[60] Y. C. Yeh, C. B. Highley, L. Ouyang, J. A. Burdick, Biofabrication 2016, 8, 045004.
[61] X. Kuang, K. Chen, C. K. Dunn, J. Wu, V. C. F. Li, H. J. Qi, ACS Appl. Mater. Interfaces 2018, 10, 7381.
[62] M. Shin, K. H. Song, J. C. Burrell, D. K. Cullen, J. A. Burdick, Adv. Sci. 2019, 6, 1901229.
[63] L. L. Wang, C. B. Highley, Y. C. Yeh, J. H. Galarraga, S. Uman, J. A. Burdick, J. Biomed. Mater. Res.—Part A 2018, 106, 865.
[64] L. Li, P. Zhang, Z. Zhang, Q. Lin, Y. Wu. A. Cheng, Y. Lin, C. M. Thompson, R. A. Smaldone, C. Ke, Angew. Chemie 2018, 130, 5199.
[65] W. Wu, A. Deconinck, J. A. Lewis, Adv. Mater. 2011, 23, 178.
[66] L. Ouyang, C. B. Highley, W. Sun, J. A. Burdick, Adv. Mater. 2017, 29, 1604983.
[67] C. B. Rodell, N. N. Dusaj, C. B. Highley, J. A. Burdick, Adv. Mater. 2016, 28, 8419.
[68] A. L. Rutz, K. E. Hyland, A. E. Jakus, W. R. Burghardt, R. N. Shah, Adv. Mater. 2015, 27, 1607.
[69] C. B. Highley, K. H. Song, A. C. Daly, J. A. Burdick, Adv. Mater. 2019, 6, 1801076.
[70] C. B. Highley, C. B. Rodell, J. A. Burdick, Adv. Mater. 2015, 27, 5075.
[71] M. Schaffner, P. A. Rahs, F. Coulter, S. Kilcher, A. R. Studart, Sci. Adv. 2017, 3, eaao6804.
[72] H. Yang, C. Li, M. Yang, Y. Pan, Q. Yin, J. Tang, H. J. Qi, Z. Suo, Adv. Funct. Mater. 2019, 29, 1901721.
[73] L. Ouyang, C. B. Highley, C. B. Rodell, W. Sun, J. A. Burdick, ACS Biomater. Sci. Eng. 2016, 2, 1743.
[74] R. A. Barry, R F. Shepherd, J. N. Hanson, R G. Nuzzo, P. Wiltzius, J. A. Lewis, Adv. Mater. 2009, 21, 2407.
[75] D. Calvet, J. Y. Wong, S. Giasson, Macromolecules 2004, 37, 7762.
[76] S. Hong, D. Sycks, H. F. Chan, S. Lin, G. P. Lopez, F. Guilak, K. W. Leong, X. Zhao, Adv. Mater. 2015, 27, 4035.
[77] K. Tian, J. Bae, S. E. Bakarich, C. Yang, R. D. Gately, G. M. Spinks, Z. Suo, J. J. Vlassak, Adv. Mater. 2017, 29, 1604827.

### ADDITIONAL REFERENCES

The devices, systems, apparatuses, modules, compositions, materials, computer program products, non-transitory computer readable medium, and methods of various embodiments of the invention disclosed herein may utilize aspects (such as devices, apparatuses, modules, systems, compositions, materials, computer program products, non-transitory computer readable medium, and methods) disclosed in the following references, applications, publications and patents and which are hereby incorporated by reference herein in their entirety (and which are not admitted to be prior art with respect to the present invention by inclusion in this section):
A. Nian S, Lian H. Gong Z. Zhemenkov M, Qin J, Cai L-H, “Molecular Architecture Directs Linear—Bottlebrush—Linear Triblock Copolymers to Self-Assemble to Soft Reprocessable Elastomer”, ACS Macro Letters. 2019; 8: 1528-1534.
B. International Patent Application Publication No. WO 2019/046840 A1, Sheiko, et al., “Self-Assembled Elastomers with Molecularly Encoded Tissue-Like Softness, Strain-Adaptive Stiffening and Coloration”, Mar. 7, 2019.
C. U.S. Patent Application Publication No. US 2020/0399414 A1. Sheiko, et al., “Self-Assembled Elastomers with Molecularly Encoded Tissue-Like Softness, Strain-Adaptive Stiffening and Coloration”, Dec. 24, 2020.
D. Xie R, Mukherjee S. Levi A E, Reynolds V G, Wang H, Chabinyc M L, Bates C M, “Room Temperature 3D Printing of Super-Soft and Solvent-Free Elastomers”, Science Advances. 2020; 6 (46): eabc6900. https://doi.org/10, 1126/sciadv.abc6900.
E. Vatanhkah-Vamosfaderani M. Keith A N, Cong Y, Liang H, Rosenthal M, Sztucki M, Clair C, Magonov S. Ivanov D A, Dorynin A V, Sheiko S S, “Chameleon-Like Elastomers with Molecularly Encoded Strain-Adaptive Stiffening and Coloration”, Science. 2018; 359 (6383): 1509-1513. https://doi.org/10.1126/science.aar5308.
F. International Patent Application Publication No. WO 2020/198404 A1, Long, et al., “Synthesis and 3D Printing of Photocurable Colloids”, 1 Oct. 2020.
G. U.S. Patent Application Publication No. US 2020/0298492 A1, Yirmibesoglu, et al., “Extrusion System for 3-D Printing of Viscous Elastomers”, 24 Sep. 2020.

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the following claims including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

What is claimed is:

1. A triblock copolymer comprising:
a linear polymer wherein said linear polymer creates glassy domains within said triblock copolymer, and
a bottlebrush polymer, wherein said bottlebrush polymer connects said glassy domains.

2. A triblock copolymer comprising:
a linear polymer, wherein said linear polymer is poly(benzyl methacrylate); and
a bottlebrush polymer, wherein said bottlebrush polymer is comprised of polydimethylsiloxane side chains, wherein said bottlebrush polymer is situated between two of said linear polymers.

3. A method of making a triblock copolymer, comprising:
synthesizing a bottlebrush polymer, and
adding one or more of said linear polymer to said bottlebrush polymer to yield said triblock copolymer.

4. The method of claim 3, wherein said synthesizing of said bottlebrush polymer is via free radical polymerization.

5. The method of claim 4, wherein synthesizing is via atom transfer radical polymerization (ATRP).

6. The method of claim 4, wherein said atom transfer radical polymerization (ATRP) is activator regenerated electron transfer (ARGET), initiators for continuous activator regeneration (ICAR ATRP), supplemental activator and reducing agent (SARA ATRP), and electrochemically mediated ATRP.

7. The method in claim 3, wherein starting materials of said bottlebrush polymer are ethylene bis(2-bromoisobutyrate) and monomethacryloxypropyl terminated polydimethylsiloxane.

8. The method in claim 3, wherein said synthesizing includes a catalyst solution.

9. The method of claim 8, wherein said catalyst solution is comprised of:
Me₆TREN and CuBr₂;
Me₆TREN and CuCl₂; or
Me₆TREN, CuCl₂ and CuBr₂.

10. The method of claim 8, further comprising removing oxygen after said synthesis.

11. The method of claim 10, further comprising adding a reducing agent.

12. The method of claim 11, wherein said reducing agent is: Sn(EH)₂ in xylene or Sn(EH)₂ in toluene.

13. The method of claim 3, further comprising heating during said synthesis and said addition of said one or more of said linear polymer.

14. The method of claim 13, where said heating is in the range of about 50 to about 70 degrees Celsius.

15. The method of claim 3, wherein said synthesizing of said triblock copolymer is via free radical polymerization.

16. The method of claim 15, wherein synthesizing is via atom transfer radical polymerization (ATRP).

17. The method of claim 15, wherein said atom transfer radical polymerization (ATRP) is activator regenerated electron transfer (ARGET), initiators for continuous activator regeneration (ICAR ATRP), supplemental activator and reducing agent (SARA ATRP), and electrochemically mediated ATRP.

18. The method in claim 15, wherein starting materials are benzyl methacrylate, and a macroinitiator.

19. The method in claim 15, wherein said synthesizing includes a catalyst solution.

20. The method of claim 15, wherein said catalyst solution is comprised of: Me₆TREN and CuBr₂;
Me₆TREN and CuCl₂; or
Me₆TREN, CuCl₂ and CuBr₂.

21. The method of claim 15, further comprising removing oxygen after said synthesizing.

22. The method of claim 21, further comprising a reducing agent.

23. The method of claim 22, wherein said reducing agent is Sn(EH)₂ in xylene or Sn(EH)₂ in toluene.

24. The method of claim 15, further comprising heating during said synthesis and said addition of said one or more of said linear polymer.

25. The method of claim 24, where said heating is in the range of about 50 to about 70 degrees Celsius.

26. The method of claim 24, where said heating is in the range of about 60 degrees Celsius.

27. A polymer network comprising a plurality of triblock copolymers, wherein:
said bottlebrush polymers configured to operate as elastic network strands; and
said linear polymers aggregate to form spherical glassy domains.

28. The polymer network of claim 27, wherein said spherical glassy domains engage in a dissociation at high temperature or in the presence of solvent, resulting in a solid-to-liquid transition of the network.

29. The polymer network of claim 28, wherein said dissociation is reversible.

30. An article comprising the polymer network of claim 27.

31. The article of claim 30, wherein said article is a solvent-free elastomer.

32. The article of claim 30, wherein said article is a gyroid.

33. The article of claim 30, wherein said article exhibits an extensibility up to 600%.

34. The article of claim 30, wherein said article has a Young's modulus minimum of about 100 Pa.

35. The article of claim 30, wherein said article is thermostable between the temperatures of about −125° C. and about 180° C.

36. The article of claim 30, wherein said article is 3D printable.

37. The article of claim 30, wherein said article contributes structurally to a medical device.

38. The article of claim 37, wherein said medical device is implantable.

39. The article of claim 30, wherein said article constitutes a portion of a vocal cord prosthesis apparatus.

40. The article of claim 30, wherein said article constitutes a permanent filler for vesicoureteral reflux.

41. A method for synthesizing a polymer network of said triblock copolymers of claim 27 comprising removing solvent.

42. A method for 3D printing an elastomer, comprising:
adding a solvent to polymer network at a specified pressure in a chamber of a 3D printer apparatus;
transferring said polymer network with said solvent from a printer nozzle of said 3D printer apparatus; and
wherein said solvent evaporates after exiting said nozzle and the glassy domains of said polymer network reassociate.
